(19) United States
(12) Patent Application Publication
(10) Pub. No.: US 2026/0023469 A1
(43) Pub. Date: Jan. 22, 2026

(54) INTERACTION METHOD, DEVICE, AND MEDIUM

(71) Applicant: Beijing Youzhuju Network Technology Co., Ltd., Beijing (CN)

(72) Inventors: Xiaojie WANG, Beijing (CN); Hao LV, Beijing (CN); Xiaomin SONG, Beijing (CN); Zhenfei CHEN, Beijing (CN); Yuxiao ZHOU, Beijing (CN); Yeteng TAN, Beijing (CN)

(21) Appl. No.: 19/269,423

(22) Filed: Jul. 15, 2025

(30) Foreign Application Priority Data
Jul. 18, 2024 (CN) 202410969107.0

(51) Int. Cl. G06F 3/04845; G06F 3/0482; G06V 20/40

(52) U.S. Cl. CPC G06F 3/04845; G06F 3/0482; G06V 20/40

(57) ABSTRACT

The present application discloses an interaction method, a device, and a medium. The method includes: displaying a target page, wherein at least one candidate video is displayed on the target page; displaying, in response to a selection operation for a target video in the at least one candidate video, a configuration region of at least one configuration item on the target page, wherein the at least one configuration item is obtained by analyzing the target video; and displaying a new video, wherein the new video is generated based on the target video and configuration information, and the configuration information is determined based on a configuration operation triggered in the configuration region.

### CROSS-REFERENCE TO RELATED APPLICATION

This application claims the priority to and benefits of the Chinese Patent Application, No. 202410969107.0, which was filed on Jul. 18, 2024. The aforementioned patent application is hereby incorporated by reference in its entirety.

### TECHNICAL FIELD

The present application relates to the field of Internet technologies, and in particular, to an interaction method and apparatus, a device, a medium, and a product.

### BACKGROUND

Some scenarios, such as video generation scenarios, sometimes have the following requirements: processing an existing video to obtain a new video.

However, it is desirable for prompt solutions to implement video processing.

### SUMMARY

The application provides an interaction method and apparatus, a device, a medium, and a product that may better implement video processing.

To achieve the above purpose, the present application provides the following technical solution.

The application provides an interaction method, which includes the following steps:
displaying a target page, wherein at least one candidate video is displayed on the target page;
displaying, in response to a selection operation for a target video in the at least one candidate video, a configuration region of at least one configuration item on the target page, wherein the at least one configuration item is obtained by analyzing the target video; and
displaying a new video, wherein the new video is generated based on the target video and configuration information, and the configuration information is determined based on a configuration operation triggered in the configuration region.

The application provides an interactive device, including:
a first display unit configured to display a target page, wherein at least one candidate video is displayed on the target page;
a first selection unit configured to display, in response to a selection operation for a target video in the at least one candidate video, a configuration region of at least one configuration item on the target page, wherein the at least one configuration item is obtained by analyzing the target video; and
a second display unit configured to display a new video, wherein the new video is generated based on the target video and configuration information, and the configuration information is determined based on a configuration operation triggered in the configuration region.

The application provides an electronic device, including: a processor and a memory, wherein the memory is configured to store an instruction or a computer program; and the processor is configured to execute the instruction or the computer program in the memory to implement the interactive method provided by the application.

The application provides a computer-readable medium with an instruction or a computer program stored thereon, when being executed on a device, causes the device to execute the interaction method provided by the application.

The application provides a computer program product, which includes a computer program carried on a non-transitory computer-readable medium, and the computer program contains program code for executing the interactive method provided by the application.

### BRIEF DESCRIPTION OF DRAWINGS

In order to explain the technical scheme in the embodiment of the application or related technology more clearly, the drawings needed in the description of the embodiment or related technology will be briefly introduced below. Obviously, the drawings in the following description are only some embodiments recorded in the application. For ordinary people in the art, other drawings can be obtained according to these drawings without creative labor.

FIG. 1 is a flow chart of an interaction method provided in an embodiment of the present application;

FIG. 2 is a schematic diagram of a target page provided in an embodiment of the present application;

FIG. 3 is a schematic diagram of a video switching provided in an embodiment of the present application;

FIG. 4 is a schematic diagram of an account name switching provided in an embodiment of the present application;

FIG. 5 is a schematic diagram of a panel for analyzing a configuration item provided in an embodiment of the present application;

FIG. 6 is a schematic diagram of a configuration region for at least one configuration item provided in an embodiment of the present application;

FIG. 7 is a schematic diagram of a configuration region for at least one configuration item provided in an embodiment of the present application;

FIG. 8 is a schematic diagram of a configuration region for at least one configuration item provided in an embodiment of the present application;

FIG. 9 is a schematic diagram of a configuration region for at least one configuration item provided in an embodiment of the present application;

FIG. 10 is a schematic diagram of a configuration region for at least one configuration item provided in an embodiment of the present application;

FIG. 11 is a schematic diagram of a configuration region for at least one configuration item provided in an embodiment of the present application;

FIG. 12 is a schematic diagram of a configuration region for at least one configuration item provided in an embodiment of the present application;

FIG. 13 is a schematic diagram of a configuration region for at least one configuration item provided in an embodiment of the present application;

FIG. 14 is a schematic diagram of a configuration region for at least one configuration item provided in an embodiment of the present application;

FIG. 15 is a schematic diagram of a configuration region for at least one configuration item provided in an embodiment of the present application;

FIG. 16 is a schematic diagram of an interaction caused by closing a configuration panel during a configuration process provided in an embodiment of the present application;

FIG. 17 is a schematic diagram of an interaction caused by switching a video during a configuration process provided in an embodiment of the present application;

FIG. 18 is a schematic diagram of a page change resulted from triggering a task implementation provided in an embodiment of the present application;

FIG. 19 is a schematic diagram of movement of a circle along a preset path provided in an embodiment of the present application;

FIG. 20 is a schematic diagram of changes of a same task in various implementation states provided in an embodiment of the present application;

FIG. 21 is a schematic diagram of an interaction for accessing an information page through a task title provided in an embodiment of the present application;

FIG. 22 is a schematic diagram of a batch operation for generating a plurality of videos for a same task provided in an embodiment of the present application;

FIG. 23 is a schematic diagram of an interaction for viewing a task history through a task searching button provided in an embodiment of the present application;

FIG. 24 is a schematic diagram of an interaction for searching for a past task through a task search provided in an embodiment of the present application;

FIG. 25 is a schematic diagram of an interaction for viewing a past task through a task center provided in an embodiment of the present application;

FIG. 26 is a schematic diagram of an interaction for searching for a result of a past task through a task center provided in an embodiment of the present application;

FIG. 27 is a structural schematic diagram of an interaction apparatus provided in an embodiment of the present application; and

FIG. 28 is a structural schematic diagram of an electronic device provided in an embodiment of the present application.

### DETAILED DESCRIPTION

It is found through study that in some video processing implementations, a person may first manually analyze an existing video based on personal experience thereof to determine characteristics that need to be retained and replaced when the video is processed. Then, based on their personal experience, the person may make or provide a material related to the characteristics that need to be replaced, such as a video, an image, and the like. Then, based on the material, the person may manually adjust the video to obtain a new video. Because a manual analysis process of a video requires a large amount of resources, such as a human resource, a time resource, and a computing resource, a video processing based on the video requires a relatively large resource overhead, resulting in difficulty of video processing. In addition, the manual adjustment process of the video also consumes a large amount of resources, such as a human resource, a time resource, and a computing resource, resulting in greater resource overhead required for the video processing by the manual adjustment, leading to higher difficulty in video processing, which affects experience of the user in video processing.

Based on the study above, in order to improve the video processing experience, an interaction method is provided in the present application, where the method including: display a target page that displays at least one candidate video, such that in response to detecting a selection operation for a target video in the candidate video, first analyzing the target video to obtain at least one configuration item, such that the configuration item is capable of representing information a user needs to provide during a processing based on the target video, such as a video of some storyboards, replacement of an object or not, and addition of a pre-roll or not; then displaying a configuration region for the configuration item on the target page, such that the user is capable of providing configuration information by performing a configuration operation in the configuration region; and then, generating a new video based on the configuration information and the target video, such that the new video has both characteristics of the target video and characteristics described by the configuration information, so that the new video has both similarities and differences with the target video, which allows the new video to better meet a video processing requirement of the user; and finally, displaying the generated new video to the user, so that the user can view, use, download, or save the new video to better implement the video processing.

Because the at least one configuration item is obtained through automatic analysis of the target video such that the user may quickly and accurately know from the configuration item the information required to provide when processing the target video, defects caused by manual analysis of the information by the user may be effectively overcome, such as defects that cost a relatively large resource overhead such as a human resource, a time resource, and a computing resource, thereby facilitating reduce the resource overhead of video processing, and further facilitating better improve the video processing experience.

In addition, because the new video is automatically generated according to the configuration information and the target video, such that the new video may satisfy both the characteristics described by the target video and the configuration information, the defects caused manual adjustment of the video by the user in video processing, such as defects that cost a relatively large resource overhead such as a human resource, a time resource, and a computing resource, thereby facilitating reduce the resource overhead of video processing, and further facilitating better improve the video processing experience.

In addition, the present application does not limit the subject for implementing the interaction method provided in the embodiment of the present application. For example, the interaction method provided in the embodiment of the present application may be applied to a terminal device. For another example, the interaction method provided in the embodiment of the present application may also be implemented through a data exchange process between the terminal device and a server. The terminal device may be a smart phone, a computer, a personal digital assistant (PDA), a tablet, or the like. The server may be a standalone server, a clustered server, or a cloud server.

To enable those skilled in the art to better understand solutions of the present application, technical solutions in the embodiments of the present application are described clearly and completely described with reference to the figures in the embodiments of the present application. It may be apparent that the described embodiments are only a part of the embodiments of the present application, but not all the embodiments. Based on the embodiments of the present application, all other embodiments obtained by those of ordinary skill in the art without creative work shall fall within the protection scope of the present application.

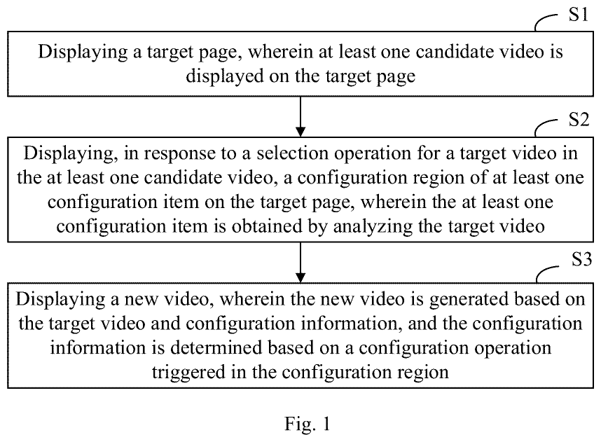

To better understand the technical solution provided in the present application, the interaction method provided in the present application is described below with reference to some accompanying drawings. As shown in FIG. 1, a method provided in the embodiments of the present application includes S1 to S3 below. FIG. 1 is a flow chart of an interaction method provided in an embodiment of the present application;

S1: displaying a target page, wherein at least one candidate video is displayed on the target page.

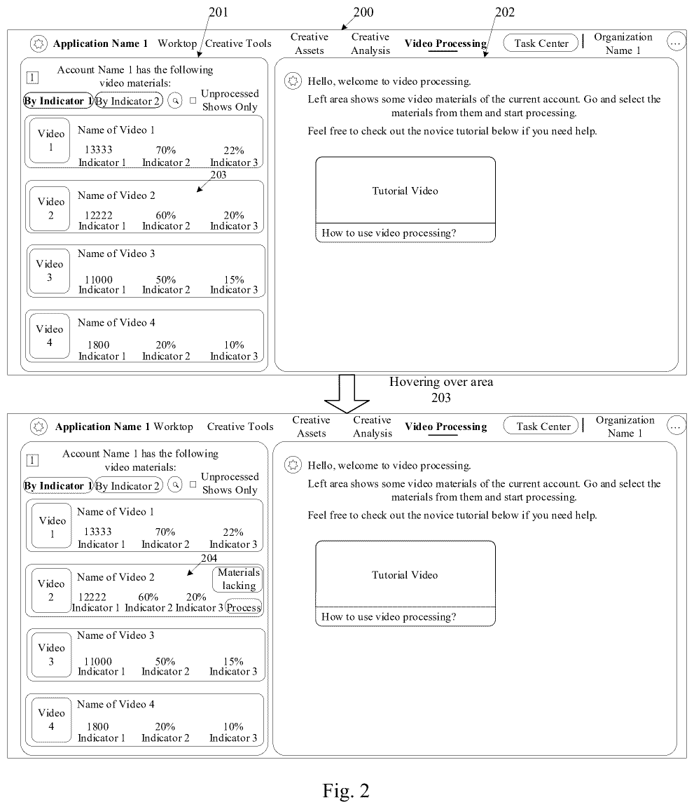

The target page refers to a page configured to provide a video processing service, as shown by a page 200 in FIG. 2.

In addition, the present application does not limit specific implementations of the video processing service. For example, in some scenarios, the video processing service may refer to the “video processing” service shown in FIG. 2. Specifically, the “video processing” service refers to processing of an existing video to obtain a new video, such that the new video not only retains an advantage of the existing video, such as an advantage of a video architecture, but also has some differences between the existing video and the new video, such as a different character.

In addition, the present application does not limit specific implementations of the target page. For example, at least one candidate video is displayed on the target page, such as video 1 to video 4 as shown in FIG. 2, such that the user may select any candidate video for processing to obtain the new video.

In addition, in some scenarios, an identifier of a target account may be displayed on the target page, such as an identifier “Account Name 1” shown in FIG. 2, such that the target page may be used to provide a video processing service for the target account, and each candidate video displayed on the target page is a video under the target account, such that subsequent users can process the video under the target account to obtain the new video.

The identifier of the target account is configured to uniquely identify the target account, and the present application does not limit specific implementations of the identifier of the target account. For example, it may be implemented by an account name, such as “Account Name 1” shown in FIG. 2. It may be seen that, in a possible embodiment, the identifier of the target account may include a name of the target account.

For another example, in order to better improve experience, the identifier of the target account may include the name of the target account and an image identifier of the target account, such as an avatar, such that the “identifier of the target account” may identify the target account through a text and an image, which allows the user to more accurately and quickly know the target account based on the “identifier of the target account”, whereby the user may effectively overcome doubts about the current account, thereby facilitating better improve the experience.

The image identifier of the target account is configured to uniquely identify the target account by means of images. Moreover, the present application does not limit the implementations of the image identifier. For example, if the target account has a corresponding avatar, the avatar is configured as the image identifier of the target account. When the avatar does not exist, a character avatar is generated based on some or all the characters in the name of the target account, such as a first character, which is configured as the image identifier of the target account.

It should be noted that, for FIG. 2, the “Account Name 1” in FIG. 2 has a certain correspondence to “Organization Name 1” in FIG. 2, and the correspondence is not limited in the present application does not limit. For example, the “Organization Name 1” corresponds to at least one account name, and the at least one account name includes the “Account Name 1”. For another example, “Account Name 1” corresponds to at least one organization name, and the at least one organization name includes the “Organization Name 1”.

In some scenarios, to better improve the experience, the identifier of the target account may be used together with other information, such as a title, to increase information diversity while imposing as little pressure on the space as possible.

Based on the preceding paragraph, the present application also provides a possible implementation of the target page, where when the target page is configured to provide a video processing service for a target account and at least one candidate video of the target page is displayed in an information panel of the target page, as shown by a panel 201 in FIG. 2, where the information panel is also displayed with a first title, and the first title is configured to describe a relationship between the target account, the at least one candidate video, and the video processing service. The first title includes first content with complete semantics, and the first content includes the identifier of the target account.

The information panel refers to a panel existing on the target page and is configured to display a candidate video, as shown by the panel 201 in FIG. 2. Moreover, the present application does not limit a position of the information panel on the target page. For example, the information panel may be located at any place on the target page.

It is found through study that a page with a structure that is “a page frame with inputs on the left and outputs on the right” may effectively reduce the cost of users in a cognitive operation, thereby better improving the experience. The present application also provides a possible implementation of the information panel, where the information panel is in a left region of the target page, as shown by the region where the panel 201 is in FIG. 2, such that the user may easily know that the video displayed on the information panel is an input required for a video generation process, which facilitates improving the experience.

In addition, the present application does not limit the way the at least one candidate video may be displayed on the information panel as described above. For example, it may be implemented in any existing or future expected way that multiple videos are distributed on the page, such as in a grid mode.

In addition, to better save space, the present application also provides a display manner for displaying the at least one candidate video on the information panel, where the at least one candidate video may be displayed in a vertical video list, as shown by a video list in the panel 201 in FIG. 2, such that the user may view other unloaded videos by triggering an up-and-down swiping or scrolling operation for the information panel.

It may be seen that in a possible implementation, when N candidate videos are displayed in the information panel in the form of a vertical video list, in response to detecting a swiping or scrolling operation triggered by the user for the information panel, other videos other than the N candidate videos are loaded and displayed on the information panel. It should be noted that the present application does not limit the number of newly loaded videos. For example, in some scenarios, 5 videos to 10 videos may be loaded with a single swipe or scroll, and the number of videos may be set according to the actual application scenario.

In addition, to improve the experience, the user can trigger a video update process for the information panel through another operation. For example, the user may trigger the video update process for the information panel by selecting a video arrangement indicator such as “By Indicator 1” or “By Indicator 2” as shown in FIG. 2. It should be noted that an indicator y is configured to describe a certain state of a video, such as a number of forwards, favorites, views, and the like, and y is a positive integer. Different indicators represent different states of the video.

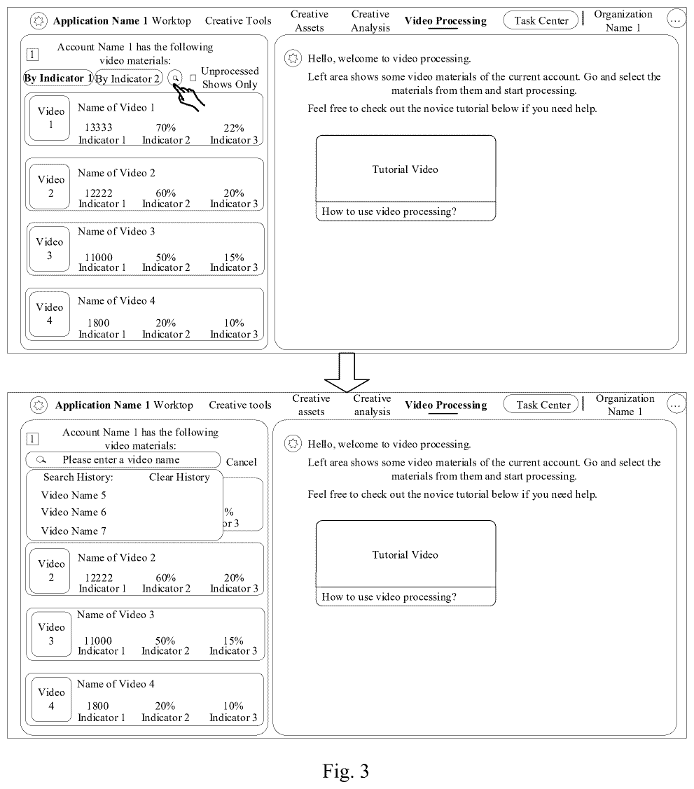

For another example, the user may use a search manner, such as the search manner as shown in FIG. 3, to trigger the video update process for the information panel. It may be seen that in a possible implementation, when the at least one candidate video and a third component are displayed on the information panel, such as a component being clicked shown in FIG. 3, in response to detecting a trigger operation for the component, a video search box, such as a search box shown in FIG. 3, is displayed on the information panel, such that the user may trigger the video update process for the information panel by entering a video name into the search box, further such that videos displayed on the updated information panel includes videos with the video name, which facilitates satisfying the video processing experience of the user.

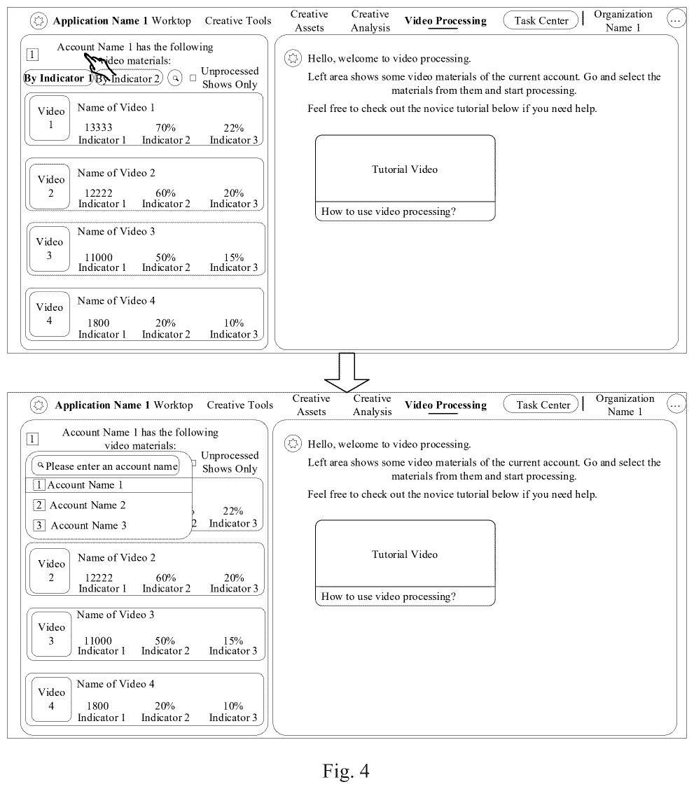

In some scenarios, when the target page is configured to provide a video processing service for the target account, the information panel of the target page is displayed with not only at least one candidate video under the target account, but also the first title, such as a title that includes at least a string “Video materials under the account name 1” as shown in FIG. 4. Thus, the first title may accurately represent characteristics of the displayed content of the information panel, such as a corresponding account that it belongs to, a type of material that it belongs to, and the like.

The first title refers to a title of the information panel, such that the first title may accurately represent the characteristics of displayed content of the information panel as much as possible, so that the first title may indicate to the user that any candidate video on the information panel may be selected for processing. In addition, the first title is located at a preset title position on the information panel. It should be noted that the present application does not limit the way in which the first title may be displayed. For example, when the first title has too much content, part of the content may be hidden by means of an ellipsis.

In addition, to better improve the information display effect, the first title may be used to describe the relationship between the target account, at least one candidate video, and the video processing service, such that the first title may accurately describe the characteristics of the information panel with as few characters as possible. Specifically, the relationship may be that the at least one candidate video belongs to the target account, each candidate video may be used to provide the video processing service, and the video processing service is provided for the target account.

In addition, the first title may satisfy the following constraint: the first content includes the first content with complete semantics, and that the first content includes the identifier of the target account. The first content refers to a string with complete semantics existing in the first title, such as the string “Video materials under the account name 1” as shown in FIG. 2, such that the identifier of the target account included in the first content may represent part of the semantics, and this part of the semantics is well connected with the semantics expressed by the other part of content other than the identifier in the first content. Therefore, the first content may express complete semantics, which effectively avoids the abruptness caused by mechanically connecting different pieces of content together, thereby facilitating to improve the experience. It should be noted that the present application does not limit the position of the “Identifier of the target account” in the first content. For example, the position may refer to a preset position.

In addition, the first title may further satisfy the following constraint: the first title occupies a text line on the information panel, such as the position of the title line, which can improve information diversity without causing additional space overhead, which facilitates improve the experience.

Furthermore, in order to better satisfy the needs of users, such as an account switching requirement, the present application also provides a possible implementation of the first title above, where the first title has the following function: in response to a trigger operation for the first title, switching the identifier of the target account in the first title to an identifier of another account, such as an “Account Name 2” or an “Account Name 4” shown in FIG. 4.

It should be noted that the present application does not limit the implementations of the switching above. For example, it may be implemented by taking turns to display of a plurality of identifiers. It may be seen that when an organization name corresponds to a plurality of account identifiers, the plurality of account identifiers include the identifier of the target account above, when the identifiers of the plurality of accounts are arranged in sequence and the first title displayed on the information panel includes a first account identifier of the plurality of account identifiers, in response to a trigger operation for the first title, the first account identifier in the first title is switched to a second account identifier, where the second account identifier is arranged adjacent to the first account identifier.

For example, in some scenarios, the account identifier may be switched through a search manner, as shown in FIG. 4. It may be seen that when an organization name corresponds to a plurality of account identifiers, and the plurality of account identifiers include the identifier of the target account above, in response to a trigger operation for the first title (for example, a trigger operation for the identifier of the target account in the first title), an account identifier search box is displayed, such as the search box shown in FIG. 4. The user may trigger a title update process of the information panel by entering an account identifier such as an account name as needed into the search box, such that the title displayed on the updated information panel includes the account identifier needed, thereby facilitating better satisfy the video processing experience of the user.

In addition, to better encourage the user to participate in the video processing, the present application further provides an interaction method, including: when an account identifier display process is triggered, in response to detecting that an indicator of an account uniquely identified by the account identifier on the video processing service reaches a preset threshold, displaying a prompt message under the account identifier, such that the indicator may be notified to the user through the prompt message, thereby encouraging the user to better participate in the video processing. It should be noted that the present application does not limit the implementation of the prompt message. For example, the prompt message may at least be configured to indicate that the indicator of the account on the video processing service reaches the preset threshold.

In some scenarios, to better improve the experience, the present application further provides a possible implementation of the information panel above, where a candidate video may be displayed on the information panel by a card, for example, a card 203 as shown in FIG. 2, such that the at least one candidate video displayed on the information panel meets the following constraint: different candidate videos are displayed on different cards, and at least the candidate video is displayed on the card corresponding to each candidate video.

In addition, in some scenarios, to better improve the information display effect, the at least one candidate video displayed on the information panel may further meet the following constraint: for any one candidate video, the card corresponding to the candidate video further displays parameter information of the candidate video, such as a video name, an indicator 1, an indicator 2, and an indicator 3.

In addition, in some scenarios, to better improve the experience, the at least one candidate video displayed on the information panel may further meet the following constraint: for any one candidate video (such as a video 2 shown in FIG. 2), in response to detecting that a mouse is hovering over a card (such as a card 203 shown in FIG. 2) corresponding to the candidate video, updating the card such that the updated card (such as a card 204 shown in FIG. 2) has a background color different from that of the card before the update. Compared with the card before the update, the updated card has at least one additional content, and the updated card has a layout different from that of the card before the update; and playing the candidate video such that the user may clearly know that the mouse is currently hovering over the card based on the changes, thereby effectively eliminating operation doubts of the user and further improving the experience. It should be noted that the present application does not limit the playback mode of the candidate video. For example, the candidate video may be played by means of a bubble (for example, playback in a silent mode).

It should be noted that for the at least one content above, the at least one content refers to an additional content included into the card in response to the mouse being hovering over the card, such as a fourth component, prompt information corresponding to a video displayed on the card, and the like. The fourth component is configured to trigger a video processing process based on the video. In addition, the present application does not limit the implementation of the fourth component. For example, it may be implemented through a processing button shown in the card 204 in FIG. 2. The prompt information is configured to prompt the user a number of videos that exist under the target account and may be used as materials for the video processing process of the video. In addition, the present application does not limit the prompt information. For example, it may be implemented through a prompt message “Materials lacking” shown in the card 204 in FIG. 2.

In addition, in some scenarios, to better improve the experience, the at least one candidate video displayed on the information panel may further meet the following constraint: for any one candidate video (such as the video 2 shown in FIG. 2), when at least one parameter of the candidate video and a corresponding parameter value are displayed on the card corresponding to the candidate video, and individual parameter names are displayed on the card by means of tags, in response to detecting a mouse being hovering over a parameter name (such as a ratio of clicks), updating the background transparency of the tag of the parameter name, and displaying relevant content of the parameter name on the card, such as a specific meaning of the parameter value corresponding to the parameter name (for example, the meaning of “Clicks on the video under the target account over the past 30 days”).

It should be noted that the present application does not limit the way of updating the transparency. For example, to better improve the experience, the transparency may be updated in the following way: the proportion of white in the transparency after the update (for example, 100%) is higher than the proportion of white in the transparency before the update (for example, 40%). In addition, the present application does not limit the display of the “Relevant content of the parameter name” described above. For example, it may be displayed by means of a bubble. In addition, the present application does not limit the timing of the update process shown above. For example, the timing of the update process occurs later than the update process of the card shown in FIG. 2.

Based on the relevant content of the S1 above, it may be seen that in some scenarios, for a terminal, such as a personal computer (PC), a target page is displayed on the terminal, such as the page 200 shown in FIG. 2, and an information panel is displayed in the left region of the target page, such as a panel 201 shown in FIG. 2, such that the information panel may display the identifier of the target account as part of the title, and some candidate videos under the target account, such as the video 1 to the video 4 as shown in FIG. 2, are displayed in a vertical video list mode to save space. In response to a mouse being hovering over a card corresponding to a candidate video, such as the card 203 shown in FIG. 2, the card is updated, so that the updated card, such as the card 204 shown in FIG. 2, has a component that can trigger the video processing process, so that the user may trigger the video processing process based on the candidate video through the component, as shown by the process shown in S2 to S3 below.

S2: displaying, in response to a selection operation for a target video in the at least one candidate video, a configuration region of at least one configuration item on the target page, wherein the at least one configuration item is obtained by analyzing the target video.

The target video refers to a video that needs to be processed, so that the new video obtained through the processing may be changed while retaining some of the advantages of the target video. The new video and the target video meet the following constraint: the new video has similarities as the target video, and the new video also has differences with the target video.

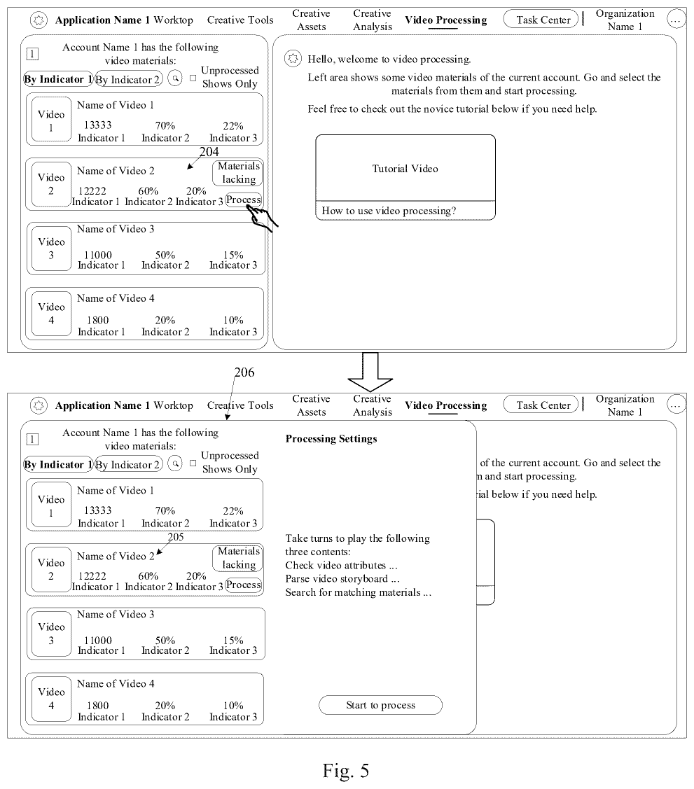

In addition, the present application does not limit the implementation of the selection operation for the target video. For example, when the target page includes a card corresponding to the target video, such as a card 204 shown in FIG. 5, the selection operation may refer to a click operation triggered for any area of the card. For another example, when a card corresponding to the target video is included on the target page, and a fourth component, such as a processing button shown by the card 204 in FIG. 5, is displayed on the target page, the selection operation may refer to a trigger operation for the fourth component, such as a click operation.

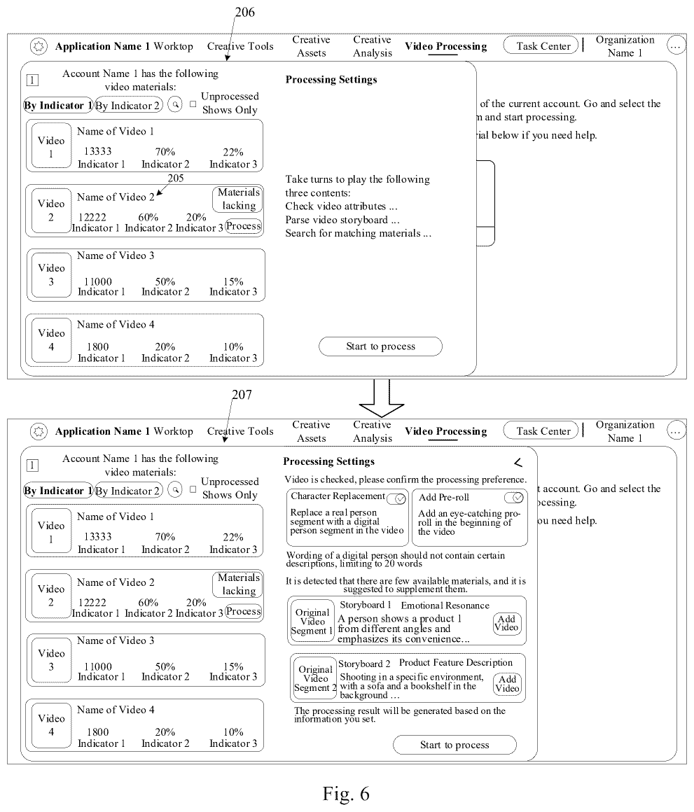

At least one configuration item refers to a configuration item available for selection when performing a processing based on the target video, such as character replacement, add pre-roll, and a storyboard 1 as shown in FIG. 6, so that the configuration item may represent information the user needs to provide when performing the processing based on the target video, for example, configuration information such as a replacement video for a storyboard, whether to replace an object, whether to add a pre-roll, and the like.

In addition, at least one configuration item is obtained by analyzing the target video, such that at least one configuration item may better represent which features in the target video that may be replaced, so that the user may accurately know from the at least one configuration item which materials that may be provided to assist the video processing process based on the target video, thereby effectively avoiding the resource overhead caused by manual analysis of the information, saving resources, and further improving the experience. It should be noted that the present application does not limit the implementation of the analysis. For example, it may include the processes of “Check a video attribute”, “Parse a video storyboard”, and “Search for matching materials” as shown in FIG. 5.

In addition, the present application does not limit the implementation of the at least one configuration item. For example, the at least one configuration item may include an object replacement configuration item, a pre-roll configuration item, and one or more of at least one candidate storyboard. For ease of understanding, the information is described below separately.

The object replacement configuration item indicates whether a preset object in the video needs to be replaced with a target object when performing the processing based on the target video. The preset object refers to an object that needs to be replaced in video processing and is preset based on an actual application scenario in advance, such as a real person. The target object refers to an object that is preset in advance according to an actual application scenario and configured to replace the preset object in video processing, such as a digital person. It may be seen that in a possible implementation, the object replacement configuration item may be configured to indicate whether the real person in the video needs to be replaced with the digital person when performing the processing based on the target video.

In addition, the object replacement configuration item may be determined based on a first analysis result of the target video, wherein the first analysis result is configured to indicate whether the preset object exists in the target video. The first analysis result is obtained by detecting a predicted object for the target video, such that the first analysis result may accurately represent whether a preset object that may be replaced, such as a real person, exists in the target video. It should be noted that the present application does not limit the implementation of the “detecting a predicted object”. For example, it may be implemented by any existing or future object detection method.

In addition, the present application does not limit the implementation of the configuration region of the object replacement configuration item. For example, it may be implemented by a card that provides a function of opening or closing a selection, such as a character replacement card shown in FIG. 6. It should be noted that the present application does not limit the implementation of the card. For example, the card may include the identifier of the object replacement configuration item, such as the name “Character replacement” as shown in FIG. 6. For another example, the card may also include content related to the object replacement configuration item, such as a specific meaning (as shown by the content “Replace a real person segment with a digital person segment in the video” in FIG. 6) and/or a constraint (as shown by the constraint “Wording of a digital person should not contain certain descriptions, limiting to 20 words” in FIG. 6).

The pre-roll configuration item is configured to indicate whether to add or replace a pre-roll in the video when performing the processing based on the target video. The pre-roll refers to an image or a video segment that exists in the first few frames of the video and has specific functions, such as advertising, summarization, eye-catching, and the like. Moreover, the present application does not limit the pre-roll.

In addition, the pre-roll configuration item may be determined based on a second analysis result of the target video, which is configured to indicate whether the target video satisfies the condition for using the pre-roll. The condition for using the pre-roll refer to a condition that is preset in advance according to an actual application scenario and needs to be met to add or replace the pre-roll during video processing. The second analysis result is obtained by determining the condition for using the pre-roll for the target video, such that the second analysis result may accurately represent whether the target video satisfies the condition for using the pre-roll, such that the second analysis result may accurately represent whether the pre-roll is allowed to be added or replaced when performing the processing based on the target video. It should be noted that the present application does not limit the implementation of the determination. For example, it may be determined by any existing or future object condition.

In addition, the present application does not limit the implementation of the configuration region of the-roll configuration item. For example, it may be implemented by a card that provides a function of opening or closing a selection, such as a pre-roll addition card shown in FIG. 6. It should be noted that the present application does not limit the implementation of the card. For example, the card may include the identifier of the pre-roll configuration item, such as the name “Add Pre-roll” as shown in FIG. 6. For another example, the card may also include content related to the object replacement configuration item, such as a specific meaning (as shown by the content “Add an eye-catching pro-roll in the beginning of the video” in FIG. 6).

At least one candidate storyboard is configured to indicate a storyboard that can be replaced when performing the processing based on the target video, such as a storyboard 1 and a storyboard 2 shown in FIG. 6. The storyboard is a technique that can illustrate an image composition by means of a diagram, and the storyboard may decompose a continuous scene in a unit of one camera movement, and mark a camera movement method, a period, a dialogue, an effect, and the like, to ensure that a visual effect and narrative rhythm of the final generated new video are in line with the creative intent.

The at least one candidate storyboard may be obtained by parsing storyboards of the target video, such that the at least one candidate storyboard may represent part or all of storyboards that exist in the target video.

In addition, the present application does not limit the process of determining the at least one candidate storyboard. For example, it includes: firstly, parsing storyboards of the target video to obtain at least one target storyboard, such that the “at least one target storyboard” is configured to represent all storyboards of the target video; determining the at least one target storyboard as the at least one candidate storyboard, so that the “at least one candidate storyboard” includes all storyboards of the target video, so that subsequent users may choose the storyboards to keep and the storyboards to replace as needed, thereby improving the video processing experience.

For another example, in some scenarios, in order to better retain the advantages of the target video, the at least one candidate storyboard above may be specifically determined as follows: firstly, parsing storyboards of the target video to obtain at least one target storyboard and tag information of each target storyboard, so that the “at least one target storyboard” is configured to represent all storyboards of the target video, and the tag information of the target storyboard is configured to indicate whether the target storyboard belongs to the advantages of the target video; then, screening out at least one non-advantage storyboard from the at least one target storyboard according to the tag information of the at least one target storyboard, so that the tag information of each non-advantage storyboard is configured to indicate an advantage of the first storyboard that does not belong to the a target video, so that the at least one non-advantage storyboard may represent other features in the target video other than advantages; then, determining the at least one non-advantage storyboard as the at least one candidate storyboard, so that the “at least one candidate storyboard” includes all non-advantage storyboards of the target video, so that subsequent users may choose the non-advantage storyboards to replace as needed, thereby improving the video processing experience.

In fact, in some scenarios, a large number of videos may exist under the target account. Therefore, to better improve efficiency, the present application also provides a method for determining at least one candidate storyboard, where when the target page is configured to provide a video processing service for the target account, the process for determining the at least one candidate storyboard displayed on the target page may include steps 11-12 below.

Step 11: parsing storyboards of the target video to obtain at least one first storyboard, such that the at least one first storyboard is configured to represent all storyboards of the target video or a non-advantage storyboard of the target video, so that the at least one first storyboard can represent a replaceable storyboard existing in the target video.

It should be noted that the present application does not limit the implementation of parsing the storyboards. For example, it may be implemented by any existing or future method that may perform the parsing on a video, for example, through a pre-created machine learning model that has the function of parsing storyboards.

It should also be noted that the present application does not limit the implementation of the at least one first storyboard above. For example, the at least one first storyboard may include the at least one storyboard above. For another example, the at least one first storyboard may include the at least one non-advantage storyboard above.

Step 12: determining the at least one candidate storyboard according to a matching result between each first storyboard and a video associated with the target account, wherein the at least one first storyboard includes the at least one candidate storyboard, and for any one of the at least one candidate storyboard, the video associated with the target account does not have any video that matches the candidate storyboard.

The video associated with the target account refers to a video that has an association relationship with the target account, such as some or all videos under the target account. It may be seen that in a possible implementation, the video associated with the target account meets the following constraint: the video associated with the target account belongs to the target account.

The matching result may represent a matching condition between the “at least one first storyboard” above and the video associated with the target account, so that the matching result may indicate: for any first storyboard, whether any video that may replace the first storyboard exists in the video associated with the target account, so that the matching result may indicate the storyboard in the target video that may be replaced by a corresponding video under the target account.

Based on the contents of steps 11 to 12 above, it may be seen that for some scenarios, after at least one first storyboard is obtained from the target video through storyboarding, for any first storyboard, the first storyboard is matched to the video associated with the target account to obtain a matching result, so that the matching result may indicate whether there is a video under the target account that can replace the first storyboard, and if not, the first storyboard is determined as a candidate storyboard, so that subsequent user may obtain a video that can replace the candidate storyboard by uploading a video, so that the at least one candidate storyboard may represent the video that exists in the target video and cannot match the video associated with the target account, so that the at least one candidate storyboard may represent a missing material, which facilitates to improve efficiency and reduce the resource pressure caused by analyzing a large number of videos.

In addition, the present application does not limit the implementation of the configuration region of the at least one candidate storyboard. For example, it satisfies at least the following constraints: the configuration regions for different candidate storyboards have different display content; and/or, for any storyboard, the display content in the configuration region of the candidate storyboard includes at least one of a type to which the candidate storyboard belongs and image description information of the candidate storyboard. The type to which the candidate belongs is configured to indicate the type to which the candidate belongs, as shown by the type “Emotional Resonance” in FIG. 6. The image description information of the candidate storyboard is configured to indicate the story information presented by the candidate storyboard, such as the story information of “A person shows a product 1 from different angles and emphasizes its convenience . . . ”, as shown in FIG. 6.

In addition, the present application does not limit the implementation of the configuration region of the at least one candidate storyboard. For example, it may be implemented by a card that provides a function of uploading a video, such as a card corresponding to the storyboard 1 shown in FIG. 6. It should be noted that the present application does not limit the implementation of the card. For example, the card may include a least a type to which the candidate storyboard belongs, the image description information of the candidate storyboard, and a triggering component for a video uploading process.

It should be noted that the present application does not limit the interaction process used in uploading a video for one candidate storyboard. For example, the process may specifically include: when the mouse hovers over the “Triggering component for a video uploading process”, adjusting a text color displayed on the component, such as darkening the text color, such that in response to detecting that a click operation is triggered for the component by the user, displaying a video uploading interface in a bubble, where the video uploading interface is configured to display content such as a video uploading requirement (such as a format, a time period, a size, a resolution, and the like), a location in which the uploaded video is stored, a cancel button, and an uploading button, such that the user may set a storage location for the uploaded video through the content “Location in which the uploaded video is stored”, and that when the user clicks the uploading button, a file selection window is called for the user to select the video to upload, thereby completing the process of providing a material for the candidate storyboard.

In addition, the present application does not limit the implementation of the S2 above. For example, it may be implemented by any method of displaying the configuration region.

In addition, in order to better improve the experience, the present application also provides a possible implementation of the S2 above, where when at least one candidate video is displayed on the information panel of the target page, the S2 may include: in response to a selection operation of the target video in the at least one candidate video, expanding the information panel, and displaying a configuration region for the at least one configuration item within the expanded region of the information panel, thereby implementing of displaying the configuration item by means expanding the panel, which allows the user to implement the configuration process efficiently, an facilitates improve the experience.

Furthermore, the present application does not limit the implementation of the step “expanding the information panel” in the preceding paragraph. For example, the step satisfies at least the following constraint: the expanded information panel covers an area larger than the area of the information panel before the expansion, such that the expanded region in the expanded information panel is configured to display configuration-related content. The expanded region is a region resulted from the expansion, that is, a region that did not exist in the information panel before the expansion, but exists in the information panel after the expansion.

For another example, to better satisfy the experience, the present application also provides an extension mode of the information panel, where when the information panel is in the left area of the target page, the expansion process of the information panel may specifically include expanding the information panel to the right so that the expanded region in the expanded information panel is located on the right side of the original region. The original region is a region that exists both on the information panel before the expansion and on the information panel after the expansion.

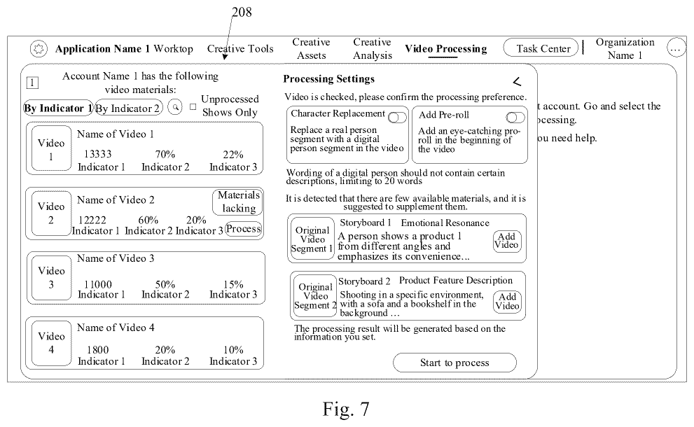

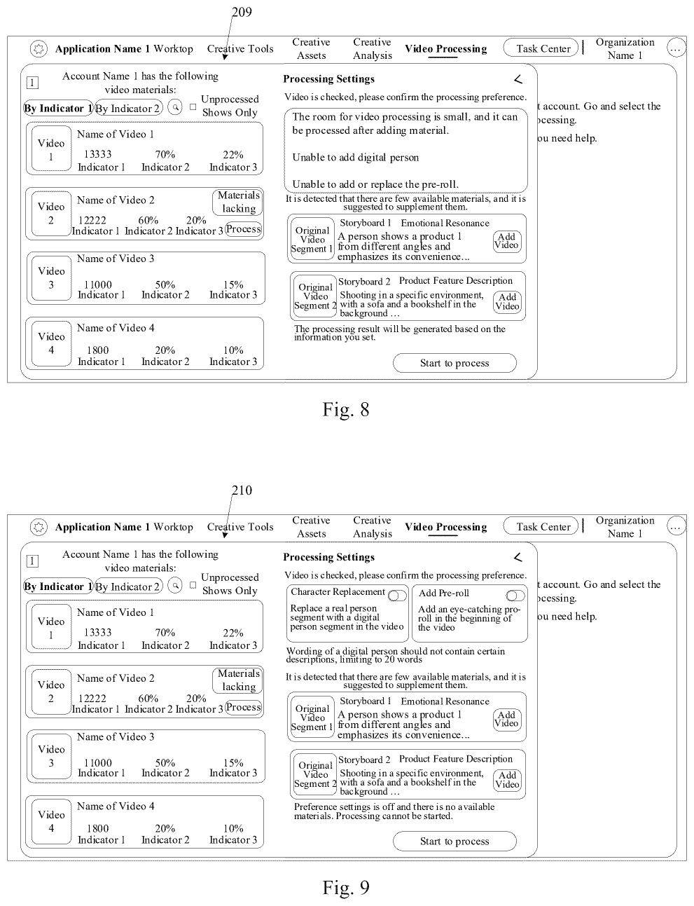

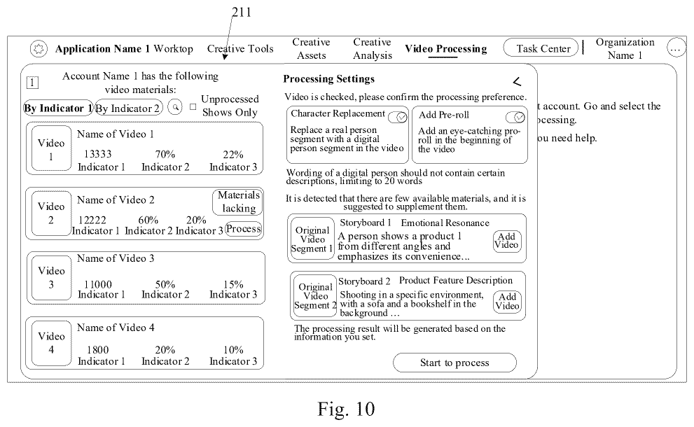

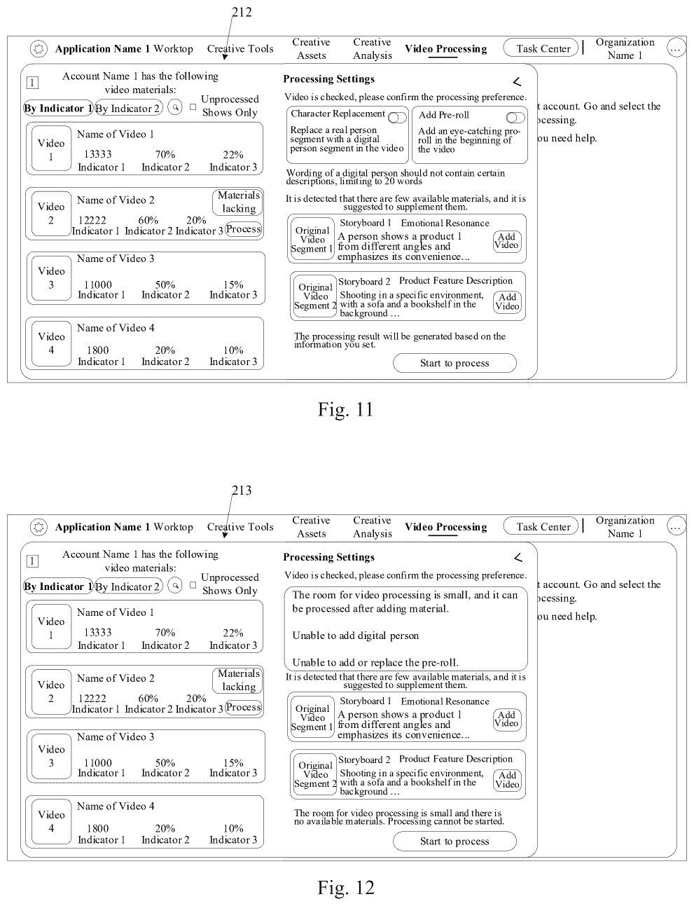

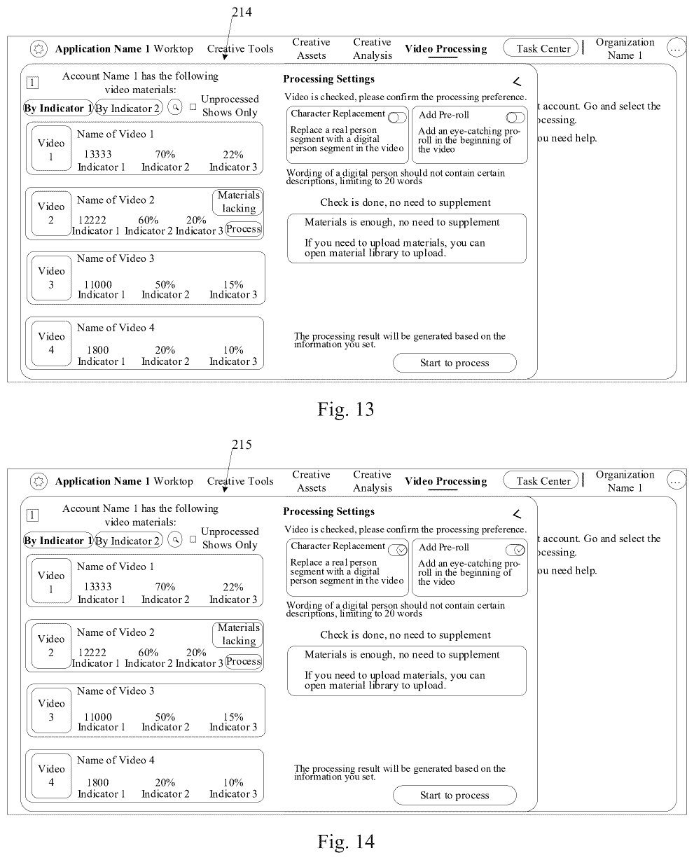

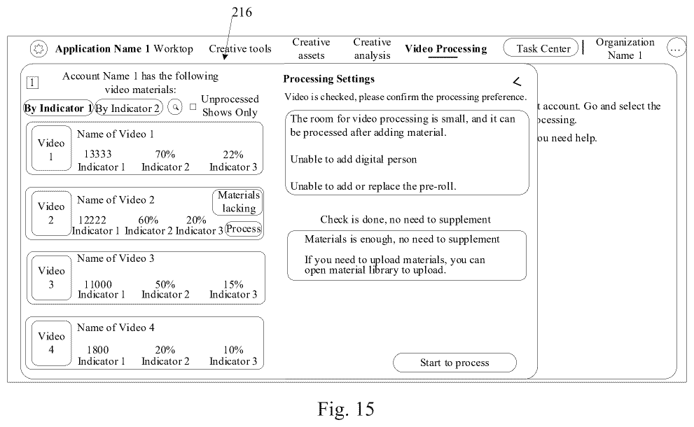

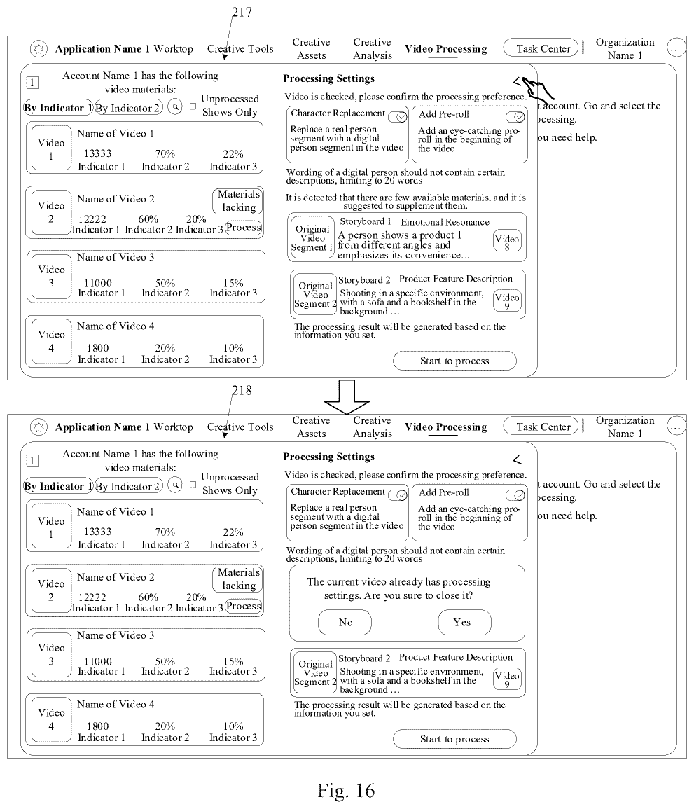

Furthermore, the present application does not limit the implementation of the information panel after the extension. For example, it may may be implemented through a panel 206 shown in FIG. 5, a panel 207 shown in FIG. 6, a panel 208 shown in FIG. 7, a panel 209 shown in FIG. 8, a panel 210 shown in FIG. 9, a panel 211 shown in FIG. 10, a panel 212 shown in FIG. 11, a panel 213 shown in FIG. 12, a panel 214 shown in FIG. 13, a panel 215 shown in FIG. 14, a panel 216 shown in FIG. 15, and a panel 217 as shown in FIG. 16.

In addition, in order to better improve the experience, the present application further provides a possible implementation of the expanded region above, where when a configuration region with at least one configuration item is displayed in the expanded region, a fifth component (such as a return button identified by the symbol < and has been clicked as shown in the panel 217 in FIG. 16) is displayed on the expanded region, so that in response to detecting a trigger operation by a user for the fifth component, prompt information is displayed (as shown by the information “Do you want to disable the processing settings for the current video?” in a panel 218 in the FIG. 16), such that the prompt information is configured to confirm with the user whether to close the expanded region. In response to detecting a confirmation operation triggered by the user for the prompt information, the prompt information is deleted, configuration that has been made for the target video is deleted, and the expanded region is closed so that the content no longer exists when the user opens the expanded region again.

It should be noted that the present application does not limit the display of the prompt information described above. For example, it may be displayed through a pop-up window. In addition, the present application also does not limit the implementation of the confirmation operation above. For example, it may be implemented by a confirmation button. In addition, the present application does not limit the way the expanded region described above is closed. For example, it may include: restoring the expanded information panel to the information panel before the expansion.

In some scenarios, in order to better improve the experience, the present application also provides a possible implementation of the expanded region above, wherein in response to that at least one candidate video is displayed on the information panel of the target page, the target video in the at least one candidate video being selected, and the configuration region for the at least one configuration item corresponding to the target video is displayed in the expanded region of the information panel, where the expanded region has a content update function shown in steps 21 to 22 below.

Step 21: displaying prompt information in response to a selection operation for a video other than the target video in the at least one candidate video, wherein the prompt information is configured to confirm with a user whether to discard configured content for the target video.

Step 22: in response to a confirmation operation triggered for the prompt information, deleting the prompt information, and updating display content in the expanded region, wherein updated display content does not include the configured content, and the updated display content is determined by analyzing the video other than the target video.

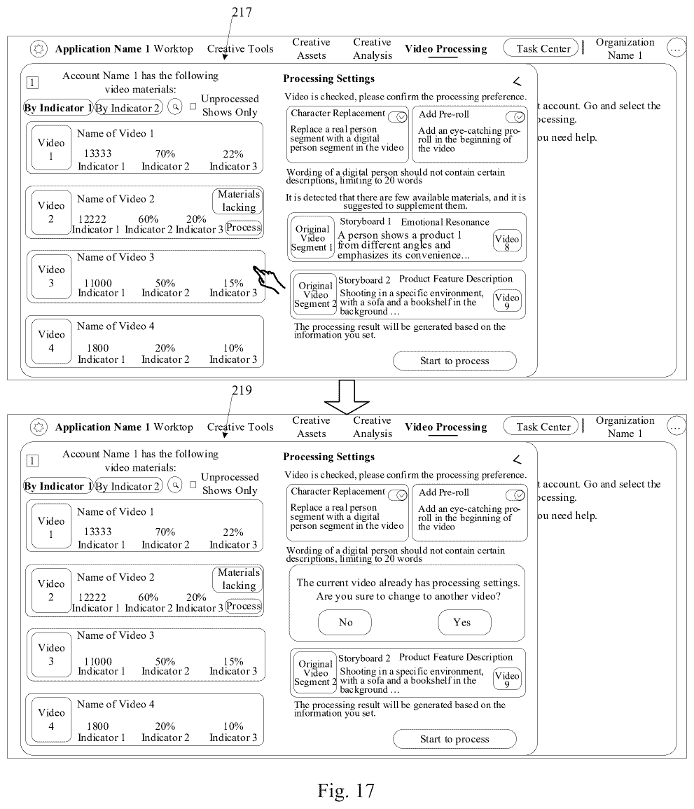

Based on the contents of steps 21 to 22 above, it may be seen that for the information panel of the target page, such as a panel 217 shown in FIG. 17, when at least one candidate video is displayed on the original region of the information panel, the target video (such as a video 2 shown in the panel 217 in FIG. 17) is selected, and the configuration region corresponding of the at least one configuration item corresponding to the target video is displayed in the expanded region of the information panel, in response to detecting a selection operation triggered for another video in the original area (such as a video 3 shown in the panel 217 in FIG. 17), prompt information is displayed on the information panel (as shown in a panel 219 in FIG. 17, such as the information “The current video has processing settings. Are you sure you want to change the video?” shown in a panel 219 in FIG. 17), such that the prompt information is configured to confirm with the user whether to discard the configuration that has been made for the target video, such as uploaded videos, so that in response to detecting a confirmation operation triggered by the user for the prompt information, the prompt information and the display content in the expanded region after the update are deleted, so that the updated display content includes the configuration region of the at least one configuration item corresponding to the another video, so that the expanded region is configured to display the configurations of the another video, and the configurations of the target video are no longer displayed, such as the content that has been configured for the target video, thereby facilitating meet a video switching need with high efficiency of the user, so as to better improve the experience.

It should be noted that the present application does not limit the display of the prompt information described above. For example, it may be displayed through a pop-up window. In addition, the present application also does not limit the implementation of the confirmation operation above. For example, it may be implemented by a confirmation button.

In some scenarios, in order to better provide an experience, the present application also provides a possible implementation of the preceding S2, where when at least one candidate video is displayed on the information panel of the target page, the S2 may specifically include: in response to a selection operation of the target video in the at least one candidate video, expanding the information panel, and displaying a preset prompt content in the expanded region of the information panel, so that the preset prompt content is configured to indicate that the target video is being analyzed, so that the preset prompt content may indicate that the at least one configuration item corresponding to the target video has not been obtained, so that after obtaining at least one configuration item, the display content in the expanded region is updated so that the updated display content includes the configuration area of the at least one configuration item.

The preset prompt content refers to content displayed within the period of [Obtaining the at least one configuration item corresponding to the target video for a period for triggering the selection operation of the target video], so that the content is configured to indicate that the at least one configuration item corresponding to the target video is being analyzed, so that the user can know the current progress from the content, thereby avoiding confusion of users.

In addition, the present application does not limit the implementation of the preset prompt content. For example, the preset prompt content may be configured to indicate a real-time analysis process for the target video. For another example, the preset prompt content may be implemented using a content display policy shown in the expanded region of the panel 206 in FIG. 5.

Based on the above three paragraphs, it may be seen that in some scenarios, for the information panel of the target page, as shown in the left panel shown in FIG. 5, when the information panel is displayed with a card corresponding to the target video, and the card includes a fourth component, such as a processing button shown by the card 204 in FIG. 5, in response to detecting a trigger operation for the fourth component, the background color of the card and the color of the fourth component are updated (as shown by a deepened color shown by the card 205 in FIG. 5), the information panel is expanded, and the preset prompt content is displayed in the expanded region of the information panel, so that the preset prompt content may convey to the user the configuration items that are required to be provided by the user in the video processing process of analyzing the target video, so that after obtaining these configuration items, the display content in the expanded region is updated, so that the updated display content includes the configuration region of the configuration items, as shown in the panel 207 in FIG. 6.

It should be noted that the updated display content described above may present different state in different situations, such as the state shown in the panel 207 in FIG. 6, the state shown in the panel 208 in FIG. 7, the state shown in the panel 209 in FIG. 8, the state shown in the panel 210 in FIG. 9, the state shown in the panel 211 in FIG. 10, the state shown in the panel 212 in FIG. 11, the state shown in the panel 213 in FIG. 12, the state shown in the panel 214 in FIG. 13, the state shown in the panel 215 in FIG. 14 and the state shown in the panel 216 in FIG. 15.

In addition, in some scenarios, in order to better improve the experience, the present application further provides a possible implementation of the S2 above, where in response to that at least one candidate video is displayed on the information panel of the target page, the S2 specifically includes: in response to that a selection operation for the target video in the at least one candidate video, the first component is displayed on the target page, and the configuration region for the at least one configuration item is displayed on the target page. The first component is configured to trigger a video generation process based on the target video. In addition, the present application does not limit the implementation of the first component. For example, it may be implemented through a “Start Processing” button shown in the FIG. 5 to FIG. 15.

In addition, the present application does not limit the display state of the first component. For example, the first component may be displayed in a first state or a second state. The first state is used to indicate that the first component is in an available state, as indicated by the “Start Processing” button shown in the panel 207 in FIG. 6. The second state is used to indicate that the first component is in an unavailable state, as indicated by the “start processing” button shown in the panel 206 in FIG. 6.

Based on the above two paragraphs, it may be seen that in some scenarios, for the information panel of the target page, as shown in the left panel shown in FIG. 5, when the information panel displays a card corresponding to the target video, and the card includes a fourth component, such as a processing button shown by the card 204 in FIG. 5, in response to detecting a trigger operation for the fourth component, the background color of the card and the color of the fourth component are updated (as shown by a deepened color shown by the card 205 in FIG. 5), the information panel is expanded, and the preset prompt content and the first component in the unavailable state are displayed in the expanded region of the information panel, so that after obtaining the at least configuration item corresponding to the target video, the first component is adjusted to the available state, such that the updated display content includes the configuration region of the at least one configuration item, as shown in the panel 207 in FIG. 6.

In addition, in some scenarios, such as the scenarios where processing is unavailable shown in FIG. 9 or FIG. 12, for the information panel, because some factors that affect video processing may exist in the target video itself, the first component needs to be kept in an unavailable state when obtaining and displaying the configuration region of the at least one configuration item corresponding to the target video, until the user is detected to complete the configuration for some or all of the configuration items, and then the first component may be adjusted to the available state, thereby facilitating avoid generating new videos with poor quality.

Based on the preceding paragraph, the present application also provides a state update method for the first component, where when the configuration region for the at least one configuration item and the first component in the second state are displayed on the target page, and the second state is configured to indicate that the first component is in an unavailable state, the state update process of the first component may include: in response to a configuration operation triggered in the configuration region, switching the first component from the second state to the first state, so that the first component is in an available state, so that subsequent users may trigger and execute a video generation task based on the target video through the first component to obtain a new video.

S3: displaying a new video, wherein the new video is generated based on the target video and configuration information, and the configuration information is determined based on a configuration operation triggered in the configuration region.

The new video refers to a video that is obtained through a processing based on the target video, so that the new video satisfies the following constraint: the new video has both similarities as the target video as well as differences with the target video, so that the new video may be changed on the premise of maintaining some characteristics of the target video, such as advantages.

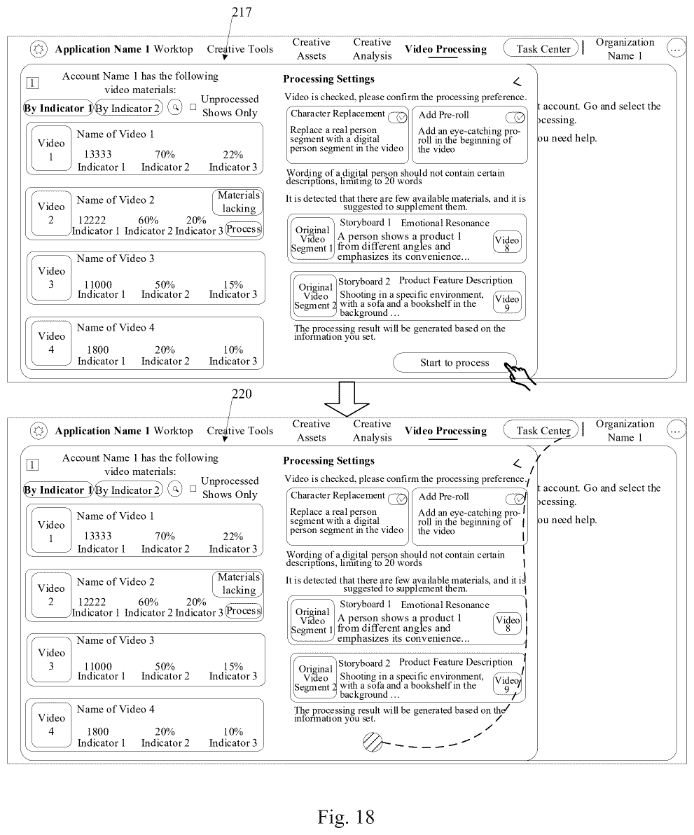

In addition, the present application does not limit the triggering mode of the display process of the new video. For example, when the first component, such as the “Start Processing” button shown in the panel 217 in FIG. 18 is displayed on the target page, the display process of the new video may be triggered in such a way that: when the first component is in the first state, displaying the new video in response to a trigger operation for the first component, where the first state is configured to indicate that the first component is in an available state.

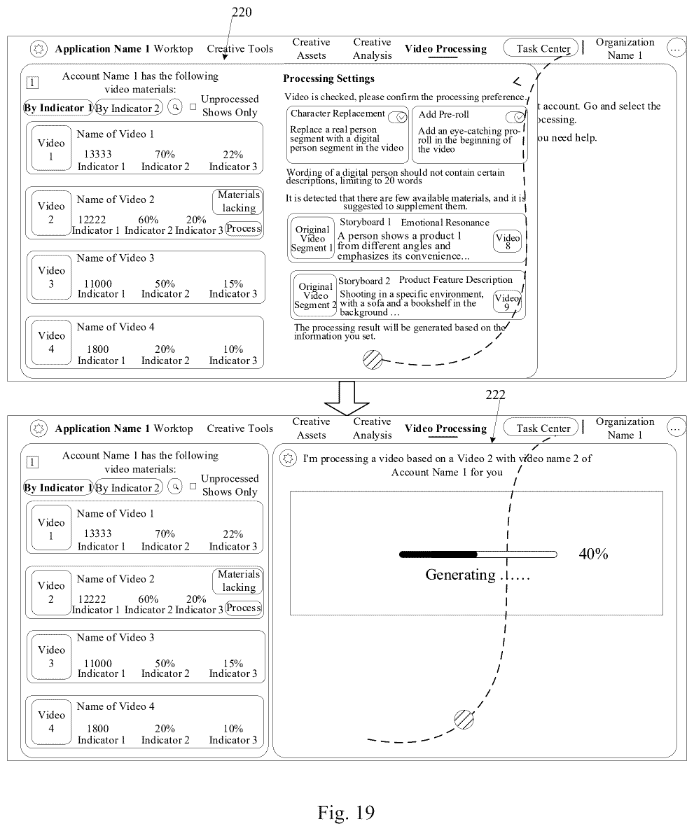

In addition, the present application does not limit the way of obtaining the new video described above. For example, in some scenarios, in response to that a user triggers a configuration operation for the configuration region of some or all of the configuration items, such as uploading a video for a storyboard, the determining the new video may be implemented by the following process: first, determining the configuration information according to the configuration operation, so that the configuration information may represent the information provided by the user through the configuration operation, so that the configuration information may represent results of configuration made by the user for the configuration items, which furthermore allows the configuration information to represent a video processing requirement of the user, such as replacing a real person with a digital person, adding a pre-roll, and replacing a corresponding storyboard with the uploaded video (as shown by using a video 8 to replace a storyboard 1 and a video 9 to replace a storyboard 2 in FIG. 18 or FIG. 19); then generating a according to the target video and the configuration information to obtain a new video, so that the new video has both some characteristics of the target video, such as advantages, and the characteristics described by the configuration information, so that the new video retains some characteristics of the target video, while satisfying the constraint described by the configuration information, so that the new video has both similarities as the target video and differences from the target video, so that the new video can better meet the video processing requirement of the user.

Also, in some scenarios, the user may not have additional requirements, so the new video may be generated based on the target video itself. Based on this, the present application further provides a method for determining a new video, where the new video may be determined through the following process: when configuration information exists, generating the new video according to the target video and the configuration information; and when no configuration information exists, generating the new video based on the target video.

It may be seen that in some scenarios, when the configuration region of the first component and the at least one configuration item is displayed on the information panel of the target page, in response to that the first component is in the available state, the user may directly click the first component without any configuration, so that a processing may be performed subsequently according to the target video to obtain and display the new video. Alternatively, the user may trigger a corresponding operation in the configuration region of some configuration items to obtain configuration information, so that a processing may be performed subsequently based on both the target video and configuration information to obtain and display the new video, to meet the different video processing needs of different users as much as possible, thereby improving the experience.

In addition, in some scenarios, some videos under the current account may be used as materials for processing. Based on this, the present application further provides a method for determining a new video, where when at least one first storyboard obtained through analyzing the target video includes a second storyboard, and a video in videos associated to a target account to which the target video belongs matches the second storyboard, the new video may be determined in the following process: in response to that configuration information exists, generating the new video according to the target video, the configuration information, and the “video that matches the second storyboard”; in response to that no configuration information exists, generating the new video based on the target video and the video that matches the second storyboard. It may be seen that in a possible implementation, the new video is further generated based on the “video that matches the second storyboard”. The second storyboard is a storyboard that exists in the target video and matches at least one video associated with the target account, such that the second storyboard may represent a storyboard that may be replaced with one or more videos associated with the target account.

It may be seen that in some scenarios, when a configuration region of a first component and at least one configuration item is displayed on the information panel of the target page, and the target video belongs to the target account, in response to that the first component is in an available state, the user may directly click the first component without any configuration, so that a processing may be performed subsequently according to the target video, and the video under the target account that matches a storyboard in the target video to obtain and display the new video. Alternatively, the user may perform a corresponding operation in a configuration region of some configuration items to obtain configuration information, such that a processing may be performed subsequently based on both the target video, the configuration information, and the video under the target account that matches a storyboard in the target video to obtain and display the new video, so as to meet the different video processing needs in various scenarios as much as possible, thereby improving the experience.

In addition, the present application does not limit the way of displaying the new video. For example, it may be implemented in any prior art or future expected way the generated video is displayed, such as in a single video.

In addition, since the processing based on the target video is a video generation task, to better improve the information display effect, the new video may be displayed in any task display mode. It may be seen that in a possible implementation, the above S3 may include: showing an execution result of a first task, wherein the first task a video generation task based on the target video, and the execution result includes the new video. The first task is configured to perform a processing based on the target video.

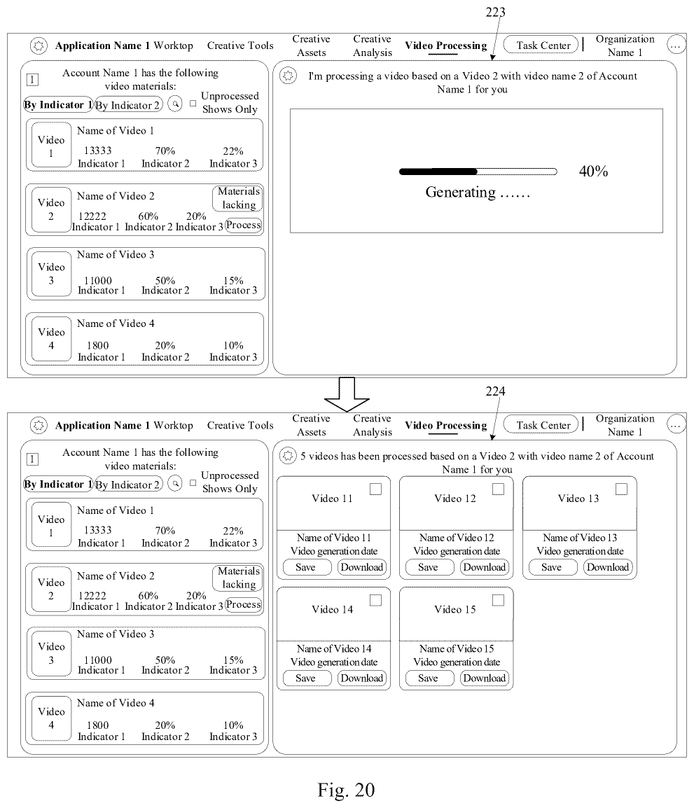

It should be noted that the present application does not limit the implementation of the execution result in described above. For example, the execution result may include at least each video generated, as shown by a video 11 to a video 15 in FIG. 20.

In addition, to better improve the experience, the present application further provides a possible implementation of the S3 above, where the S3 may specifically include: showing an execution result of a first task on a result panel of the target page, where the first task is a video generation task based on the target video, and the execution result includes the new video.

The result panel refers to a panel that exists on the target page and is configured to display the execution result of each video generation task, such as a panel 202 as shown in FIG. 2, a panel 222 as shown in FIG. 19, a panel 223 as shown in FIG. 20, or a panel 224 as shown in FIG. 20.

In addition, the present application does not limit the position of the result panel on the target page. For example, when the information panel on the target page is in the left region, the result panel may be in the right region of the target page, so that the target page presents “a page frame with inputs on the left and outputs on the right”, thereby facilitating reduce the difficulty of operation by the user.

In addition, in order to better improve the experience, the present application further provides a possible implement of the result panel above, where the result panel is not only configured to display the new video, but may also be configured to: display a second title corresponding to the new video, wherein the second title is configured to indicate that the new video is generated based on the target video, and the second title includes a second content with complete semantics, and the second content includes the identifier of the target video.

The second title refers to a title displayed on the result panel to describe a title of a video generation task based on the target video, as shown in a panel 224 in FIG. 20, including a title that include a string “I have processed 5 videos for you based on the video name 2 of the account name 1”, such that the second title may be configured as the title of the video generation task.

In addition, when the execution result of the video generation task based on the target video includes the new video, the preceding second title may satisfy the following constraint: the second title is configured to indicate that the new video is generated based on the target video, the second title includes a second content with complete semantics, and the second content includes the identifier of the target video.

The second content refers to a string with complete semantics existing in the second title, such as the string “I have processed 5 videos based on the video name 2 of the account name 1” as shown in FIG. 20, such that the identifier of the target video included in the second content may represent part of the semantics, and this part of the semantics is well connected with the semantics expressed by the other part of content other than the identifier in the second content, such that the second content may express complete semantics, which effectively avoids the abruptness caused by mechanically connecting different pieces of content together, thereby facilitating improve the experience. It should be noted that the present application does not limit the position of the “identifier of the target video” in the second content. For example, the position may refer to a preset position.

In addition, the present application does not limit the implementation of the identifier of the target video included in the second title above. For example, it may include a video name and an image identifier. The image identifier is configured to uniquely identify the target video by means of an image, and the present application does not limit the image identifier. For example, the image identifier may be implemented by means of an identifying image specified in advance for the target video. For another example, the image identifier may be implemented using any frame of the target video.

In addition, to better improve the experience, the present application provides a possible implementation of the second title, where the second title also satisfies the following constraint: in response to a trigger operation for the identifier of the target video in the second title, displaying an information page that includes the target video and the configuration information described above.

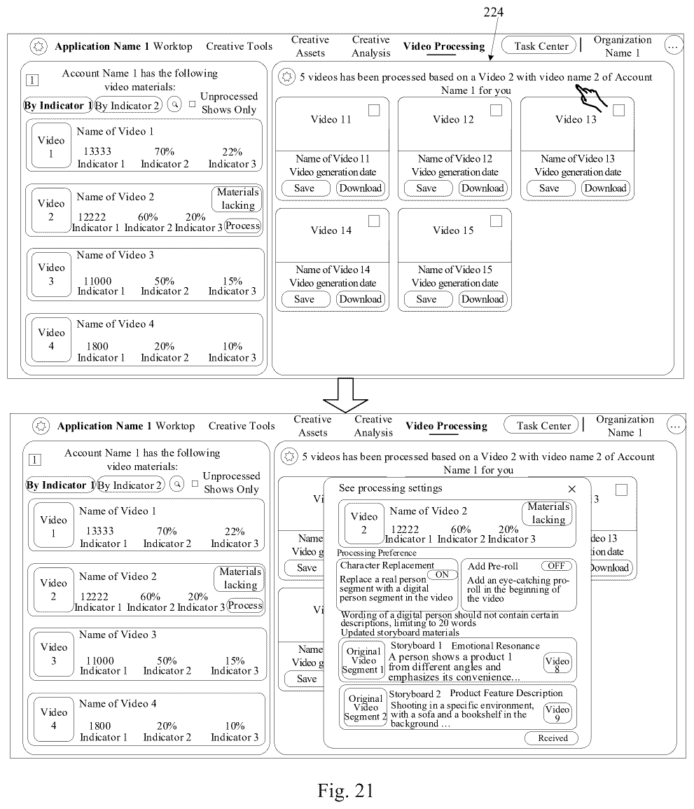

The information page is configured to display the content that needs to be used when generating the new video, such as the target video and the configuration information provided by the user. Moreover, the present application does not limit the implementation of the information page. For example, it may be implemented using a page 225 as shown in FIG. 21. For another example, the information page may: in response to that the configuration information exists, include the target video and the configuration information; and in response to that no configuration information exists, include the target video.

Further, in order to better improve the experience, the present application further provides a possible implementation of the second title, where when the target page is configured to provide the video processing service for the target account, the second title displayed on the target page also satisfies the following constraint: the second content in the second title also includes the identifier of the target account, so that the second title is specifically configured to indicate that the new video is generated based on the target video under the target account.

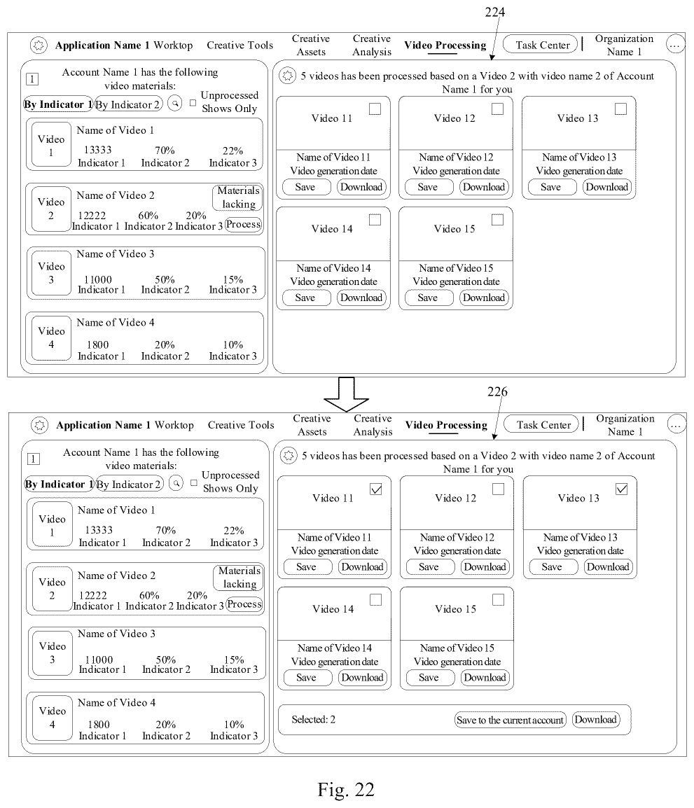

Based on the content of the new video described above, it may be seen that in some scenarios, when the information panel of the target page displays the first component, such as the “start processing” button shown in FIG. 18, and the first component is in the available state, in response to detecting a trigger operation for the first component, the first component is transformed into a circle (such as the circle shown by a panel 220 in FIG. 18), so that the circle may move along a preset path (such as the dashed path shown in FIG. 18 or FIG. 19), so that in response to detecting that the circle moves to the outside of the information panel, the information panel is restored to the state before expansion (as shown by the state of the panel 221 in FIG. 19) and the result panel of the target page is in the available state (as shown by the state of a panel 222 in in FIG. 19), so that the circle may be deleted when the circle is detected to move over or close to a task center component, so that the user may know that the execution progress of the current task may be viewed from the task center based on the movement process of the circle. In addition, the result panel (such as the panel 222 shown in FIG. 19 or a panel 223 shown in FIG. 20) further displays information on the current task (such as the name of the account to which it belongs, the name of the video to be processed, the execution progress of the current task, or the like), so that after the current task is executed, the result of the current task and associated information, such as the name of the account to which it belongs and the name of the processed video are displayed on the result panel (as shown by a panel 224 in FIG. 20), so that the user may use the content displayed on the result panel to perform another operation, such as viewing the information on which the video processing is based by the video name, as shown in FIG. 21, and a batch operation for multiple videos under the same task through multi-check boxes as shown in a panel 226 in FIG. 22.

It may be seen that in a possible implementation, where the result panel of the target page displays the execution result of the first task, the first task is a video generation task based on the target video, and the execution result includes a plurality of new videos, when the result panel also displays a selection box corresponding to each new video, in response to a check operation for selection boxes corresponding to some or all of the new videos, the number of selected videos and some components, such as renaming, downloading, saving, and other components, are displayed below the execution result, thereby meeting the batch operation needs of the user.

It may be seen from the content of the S1 to S3 above that for the interaction method provided in the present application, when a target page is being displayed and at least one candidate video is displayed on the target page, in response to detecting a selection operation for a target video in the candidate video, the target video is first analyzed to obtain at least one configuration item, such that the configuration item may represent information a user needs to provide during a processing based on the target video, such as a video of some storyboards, whether to replace an object, and whether to add a pre-roll; then, a configuration region for the configuration item is displayed on the target page, such that the user may provide configuration information by performing a certain configuration operation in the configuration region; and then, a new video is generated based on the configuration information and the target video, such that the new video has both characteristics of the target video and characteristics described by the configuration information, so that the new video has both similarities and differences with the target video, which may allow the new video to better meet a video processing requirement of the user; and finally, the generated new video is displayed to the user, so that the user may view, use, download, or save the new video to better implement the video processing.

Because the at least one configuration item is obtained through automatic analysis of the target video such that the user may quickly and accurately know from the configuration item the information required to provide when processing the target video, defects caused by manual analysis of the information by the user may be effectively overcome, such as defects that cost a relatively large resource overhead such as a human resource, a time resource, and a computing resource, thereby facilitating reduce the resource overhead of video processing, and further facilitating better improve the video processing experience.

In addition, because the new video is automatically generated according to the configuration information and the target video, such that the new video may satisfy both the characteristics described by the target video and the configuration information, the defects caused manual adjustment of the video by the user in video processing, such as defects that cost a relatively large resource overhead such as a human resource, a time resource, and a computing resource, thereby facilitating reduce the resource overhead of video processing, and further facilitating better improve the video processing experience.

In some scenarios, the user may need to query a task. Therefore, to better meet the need, the present application further provides a possible implementation of the interaction method above, where when a result panel of the target page displays an execution result of a first task, the first task is a video generation task based on the target video, and the execution result includes the new video, the interaction method may at least include step 31 to step 32 below. The step 31 is executed at a time point later than that of the S3 above.

Step 31: updating the result panel in response to a trigger operation for a second component in the result panel, wherein the updated result panel includes a result display region and a task search region, the result display region displays the execution result of the first task, and the task search region includes at least one historical task.

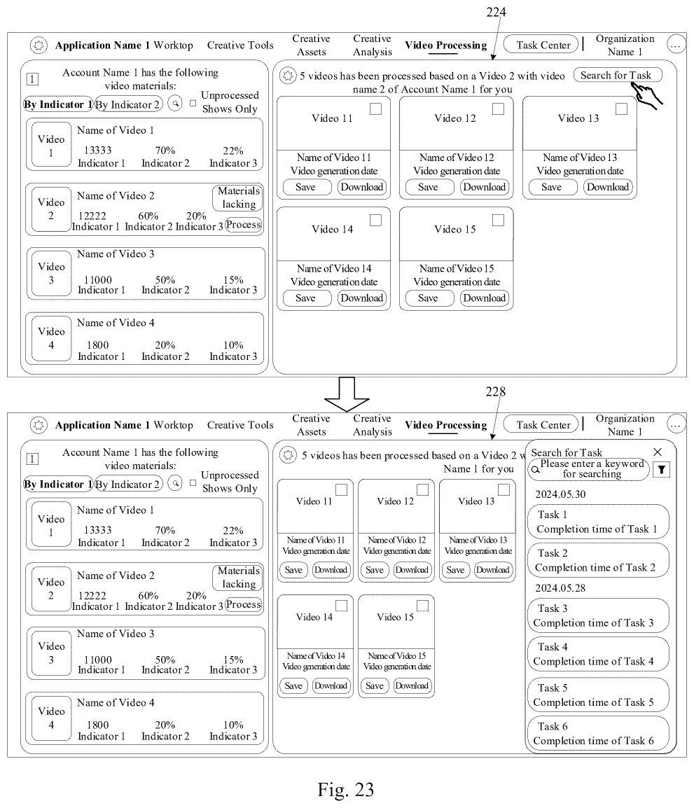

The second component refers to a component displayed on the result panel of the target page that is configured to trigger a task search process, as shown in FIG. 23.

In addition, the present application does not limit the timing when the second component appears. For example, specifically, in response to detecting a preset number of video generation tasks that have been executed exist under the target account, the second component is displayed on the result panel, such that the user may search for the video generation tasks that have been executed and execution results thereof through the second component. The preset number may be set according to the actual application scenario.

In addition, the present application does not limit the update process of the result panel. For example, specifically, the result panel is divided into two regions, namely, a result display region and a task search region, so that the result display region is configured to display the content displayed by the result panel before the update, and the task search region is configured to display a search box and all the video generation tasks that have been executed under the target account, so that the user may query a historical task and an execution result thereof through the task search region.

Step 32: displaying, in response to a selection operation for the second task in the at least one historical task, an execution result of the second task in the result display region; alternatively, displaying, in response to a keyword entered in a search box in the task search region, an execution result of a historical task that matches the keyword in the result display region.

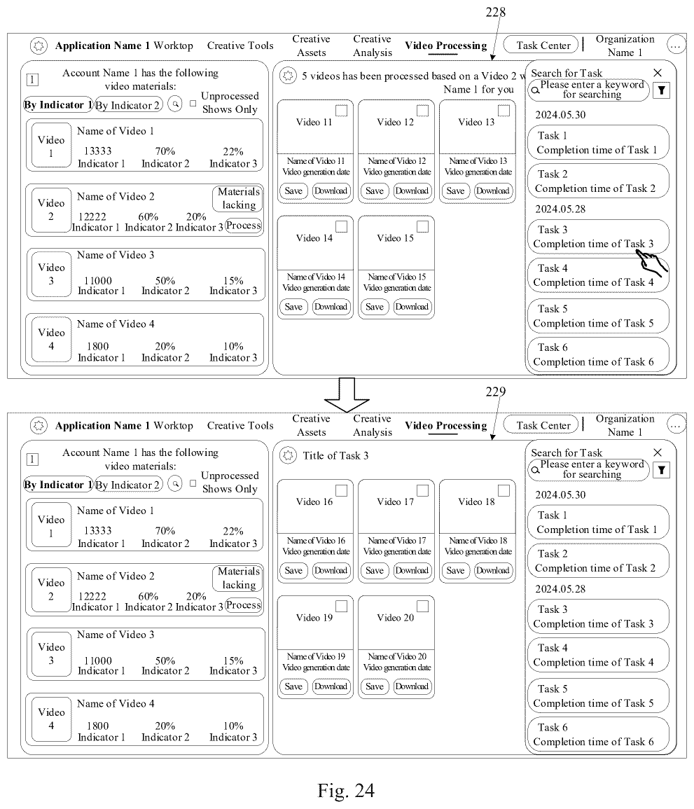

Based on the content of step 31 to step 32 above, it may be seen that the present application provides a historical task search interaction scheme, such as the search interaction scheme shown in a panel 227 in FIG. 23→a panel 228 in FIG. 23 or in FIG. 24→a panel 229 in FIG. 24, so that the scheme supports searching all historical tasks, so that the user may trace back any historical record, thereby avoid waste of historically generated videos.

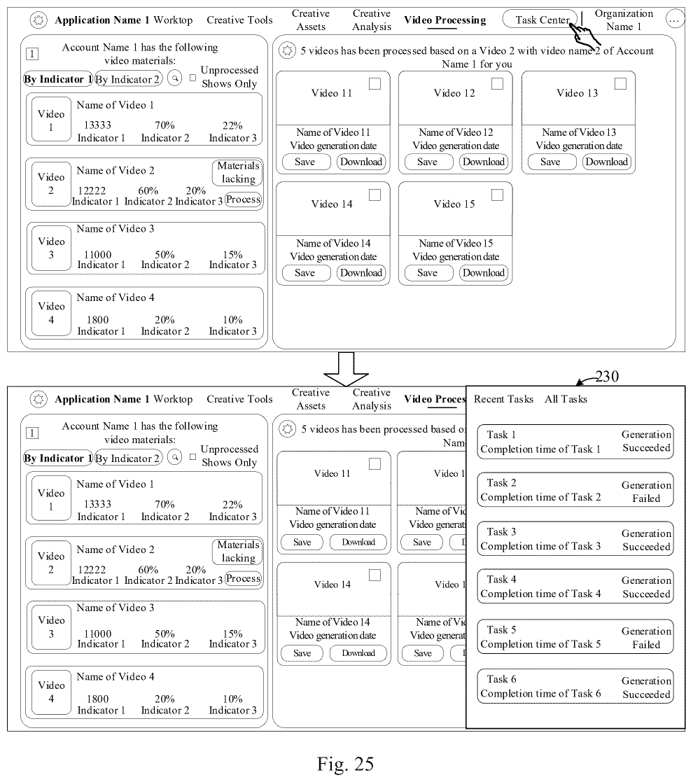

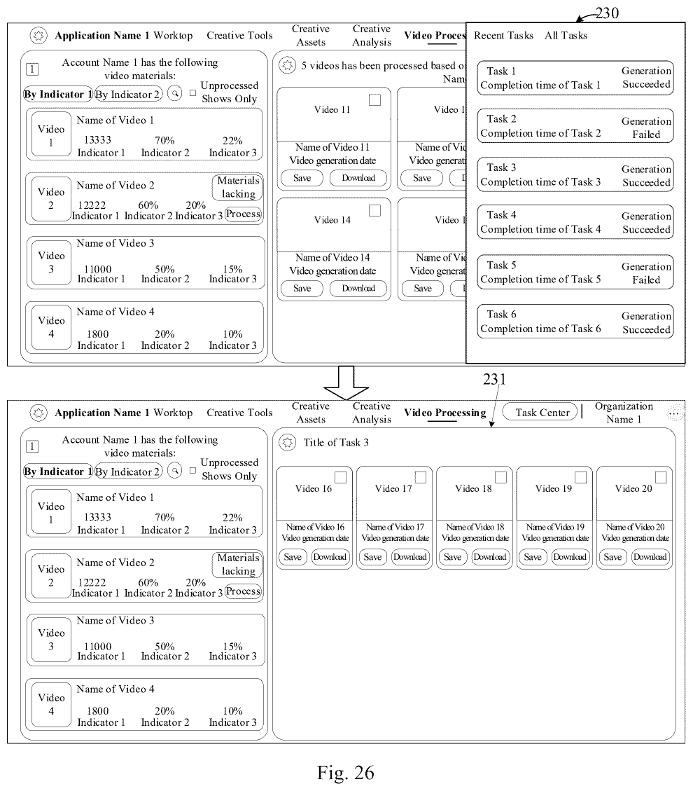

In addition, in some scenarios, the user may also view historical tasks through a task center. Based on this, the present application further provides a process of viewing historical tasks that: in response to a trigger operation for a task center component by the user, displays a task center page, such as a page 230 shown in FIG. 25, so that the task center page is configured to display the tasks that have been executed under the target account, such as a task that has been successfully executed and a task that has failed to be executed, so that in response to detecting a selection for any task on the task center page, such as a task 3 shown in FIG. 26, closes the task center page, displays the execution result of the selected task on the result panel of the target page, as shown by the execution result of the task 3 in a panel 231 in FIG. 26.

It may be seen that the present application provides a task center click backfill anchoring and forward-and-back loading logic that specifically: in response to an anchoring selection for a historical task by the user on the task center page, as shown by the task 3 in FIG. 26, performs a backfill and quickly finds an execution result of the historical task and execution results of some tasks adjacent to the historical task, and then loads these execution results sequentially onto the result panel of the target page, so that the user may see these results. It should be noted that to better improve the real-time performance, the number of adjacent tasks may be set according to the actual application scenario. In addition, when displaying these execution results on the result panel, the execution result of the historical task needs to be highlighted, so that the user may accurately know the execution result of the historical task that has been anchored, thereby facilitating improve the query experience of the user.

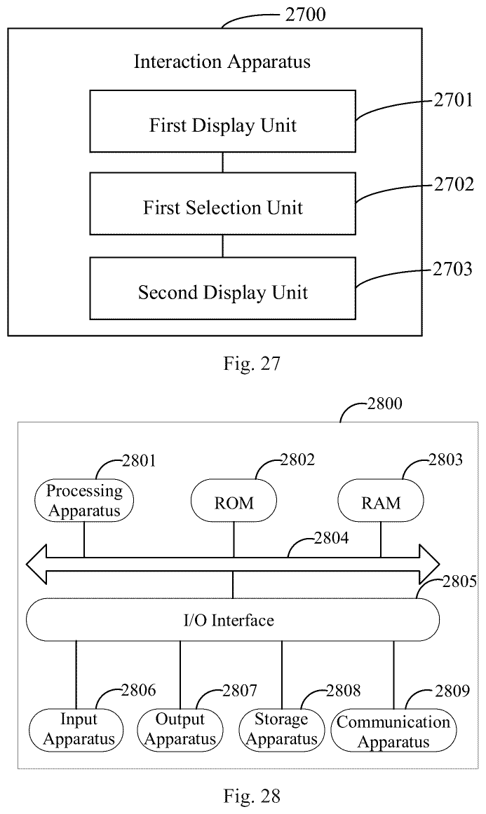

Based on the interactive method provided in the embodiments of the present application, the embodiments of the present application also provide an interaction apparatus that is explained and illustrated below with reference to FIG. 27. FIG. 27 is a structural schematic diagram of an interaction apparatus provided in an embodiment of the present application. It should be noted that the technical details of the interaction apparatus provided in the embodiments of the present application refer to the content of the interaction method above.

As shown in FIG. 27, an interaction apparatus provided in the embodiments of the present application includes:
a first display unit 2701 configured to display a target page, wherein at least one candidate video is displayed on the target page;
a first selection unit 2702 configured to display, in response to a selection operation for a target video in the at least one candidate video, a configuration region of at least one configuration item on the target page, wherein the at least one configuration item is obtained by analyzing the target video; and
a second display unit 2703 configured to display a new video, wherein the new video is generated based on the target video and configuration information, and the configuration information is determined based on a configuration operation triggered in the configuration region.

In a possible implementation, the at least one configuration item includes at least one or more of the group consisting of an object replacement configuration item, a pre-roll configuration item, and at least one candidate storyboard; the object replacement configuration item is determined based on a first analysis result of the target video, wherein the first analysis result is configured to indicate whether a preset object exists in the target video; the pre-roll configuration item is determined based on a second analysis result of the target video, wherein the second analysis result is configured to indicate whether the target video satisfies a condition for using a pre-roll; and the at least one candidate storyboard is obtained by parsing storyboards of the target video.

In a possible implementation, display content in different configuration regions of the candidate storyboard are different; and/or, for any one of the at least one candidate storyboard, display content in the configuration region of the candidate storyboard includes at least one of the group consisting of a type to which the candidate storyboard belongs and image description information of the candidate storyboard.

In a possible embodiment, the target page is configured to provide a video processing service for a target account.

The process of determining at least one candidate storyboard includes:

parse storyboards of the target video to obtain at least one first storyboard; determine the at least one candidate storyboard according to a matching result between each first storyboard and a video associated with the target account, wherein the at least one first storyboard includes the at least one candidate storyboard, and for any one of the at least one candidate storyboard, the video associated with the target account does not have any video that matches the candidate storyboard.

In a possible embodiment, the at least one first storyboard further includes a second storyboard, and the video associated with the target account has a video that matches the second storyboard; and the new video is further generated according to the video that matches the second storyboard.

In a possible embodiment, the first selection unit 2702 is further configured to: display a first component on the target page in response to a selection operation.

The second display unit 2703 is specifically configured to: when the first component is in a first state, display the new video in response to a trigger operation for the first component, wherein the first state is configured to indicate that the first component is in an available state.

In a possible embodiment, the first selection unit 2702 is specifically configured to: display, in a second state, the first component on the target page, wherein the second state is configured to indicate that the first component is in an unavailable state.

The interaction apparatus 2700 further includes:
a state switching unit configured to switch the first component from the second state to the first state in response to a configuration operation.

In a possible embodiment, the at least one candidate video is displayed on an information panel of the target page.

The first selection unit 2702 is further configured to: expand the information panel in response to the selection operation.

The first selection unit 2702 is specifically configured to: display the configuration region of the at least one configuration item in an expanded region of the information panel.

In a possible implementation, the interaction apparatus 2700 further includes:
a second selection unit configured to display prompt information in response to a selection operation for a video other than the target video in the at least one candidate video, wherein the prompt information is configured to confirm with a user whether to discard configured content for the target video; and
a first update unit configured to in response to the confirmation operation triggered for the prompt information, delete the prompt information, and update the display content in the expanded region, wherein updated display content does not include the configured content, and the updated display content is determined by analyzing the video other than the target video.

In a possible implementation, the target page is configured to provide a video processing service for a target account; the at least one candidate video is displayed on an information panel of the target page; and a first title is further displayed on the information panel, wherein the first title is configured to describe a relationship between the target account, the at least one candidate video, and the video processing service, and the first title includes first content with complete semantics, where the first content includes an identifier of the target account.

In a possible implementation, the interaction apparatus 2700 further includes:
an account switching unit configured to, switch the identifier of the target account in the first title to an identifier of another account in response to a trigger operation for the first title.

In a possible implementation, the second display unit 2703 is further configured to display a second title corresponding to the new video, wherein the second title is configured to indicate that the new video is generated based on the target video, and the second title includes a second content with complete semantics, and the second content includes the identifier of the target video.

In a possible implementation, the interaction apparatus 2700 further includes:
a configuration display unit configured to display an information page in response to a trigger operation for the identifier of the target video in the second title, wherein the information page that includes the target video and the configuration information.

In a possible implementation, the target page is configured to provide the video processing service for the target account; the second title is specifically configured to indicate that the new video is generated based on the target video under the target account; and the second content further includes the identifier of the target account.

In a possible implementation, the second display unit 2703 further configured to display an execution result of a first task on a result panel of the target page, wherein the first task is a video generation task based on the target video, and the execution result includes the new video.

The interaction apparatus 2700 further includes:
a second update unit configured to update the result panel in response to a trigger operation for a second component in the result panel, wherein the updated result panel includes a result display region and a task search region, the result display region displays the execution result of the first task, and the task search region includes at least one historical task; and
a third display unit configured to display, in response to a selection operation for the second task in the at least one historical task, an execution result of a second task in the result display region; alternatively, display, in response to a keyword entered in a search box in the task search region, an execution result of a historical task that matches the keyword in the result display region.

In a possible implementation, when the configuration information exists, the new video is generated based on the target video and the configuration information; when the configuration information does not exist, the new video is generated based on the target video.

It may be seen from the content of the interaction apparatus 2700, the interaction apparatus 2700 provided in the present application has the following working principle: displaying a target page such that at least one candidate video is displayed on the target page, so that in response to detecting a selection operation for a target video in the candidate video, the target video is first analyzed to obtain at least one configuration item, such that the configuration item may represent information a user needs to provide during a processing based on the target video, such as a video of some storyboards, replacement of an object or not, and addition of a pre-roll or not; then, displaying a configuration region for the configuration item on the target page, such that the user may provide configuration information by performing a certain configuration operation in the configuration region; and then, generating a new video based on the configuration information and the target video, such that the new video has both characteristics of the target video and characteristics described by the configuration information, so that the new video has both similarities and differences with the target video, which may allow the new video to better meet a video processing requirement of the user; and finally, displaying the generated new video to the user, so that the user may view, use, download, or save the new video to better implement the video processing. Because the at least one configuration item is obtained through automatic analysis of the target video such that the user may quickly and accurately know from the configuration item the information required to provide when processing the target video, defects caused by manual analysis of the information by the user may be effectively overcome, such as defects that cost a relatively large resource overhead such as a human resource, a time resource, and a computing resource, thereby facilitating reduce the resource overhead of video processing, and further facilitating better improve the video processing experience. In addition, because the new video is automatically generated according to the configuration information and the target video, such that the new video may satisfy both the characteristics described by the target video and the configuration information, the defects caused manual adjustment of the video by the user in video processing, such as defects that cost a relatively large resource overhead such as a human resource, a time resource, and a computing resource, thereby facilitating reduce the resource overhead of video processing, and further facilitating better improve the video processing experience.

In addition, the embodiments of the present application provide an electronic device including a processor and a memory, where the memory is configured to store an instruction or a computer program, and the processor is configured to execute the instruction or the computer program in the memory such that the electronic device performs any implementation of the interaction method provided in the embodiments of the present application.

Referring to FIG. 28, FIG. 28 illustrates a schematic structural diagram of an electronic device 900 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 28 is merely an example, and should not pose any limitation to the functions and the range of use of the embodiments of the present disclosure.

As illustrated in FIG. 28, the electronic device 2800 may include a processing apparatus 2801 (e.g., a central processing unit, a graphics processing unit, etc.), which can perform various suitable actions and processing according to a program stored in a read-only memory (ROM) 2802 or a program loaded from a storage apparatus 2808 into a random-access memory (RAM) 2803. The RAM 2803 further stores various programs and data required for operations of the electronic device 2800. The processing apparatus 2801, the ROM 2802, and the RAM 2803 are interconnected by means of a bus 2804. An input/output (I/O) interface 2805 is also connected to the bus 2804.

Usually, the following apparatus may be connected to the I/O interface 2805: an input apparatus 2806 including, for example, a touch screen, a touch pad, a keyboard, a mouse, a camera, a microphone, an accelerometer, a gyroscope, or the like; an output apparatus 2807 including, for example, a liquid crystal display (LCD), a loudspeaker, a vibrator, or the like; a storage apparatus 2808 including, for example, a magnetic tape, a hard disk, or the like; and a communication apparatus 2809. The communication apparatus 2809 may allow the electronic device 2800 to be in wireless or wired communication with other devices to exchange data. While FIG. 28 illustrates the electronic device 2800 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 2809 and installed, or may be installed from the storage apparatus 2808, or may be installed from the ROM 2802. When the computer program is executed by the processing apparatus 2801, the above-mentioned functions defined in the methods of some embodiments of the present disclosure are performed.

The electronic equipment provided by the embodiment of this disclosure belongs to the same inventive concept as the method provided by the above embodiment, and the technical details not described in detail in this embodiment can be found in the above embodiment, and this embodiment has the same beneficial effects as the above embodiment.

The embodiment of the application also provides a computer-readable medium, wherein instructions or computer programs are stored in the computer-readable medium, and when the instructions or computer programs run on a device, the device is caused to execute any implementation of the interaction method provided by the embodiment of the application.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to perform the method as described in the above embodiments.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, the first acquisition unit can also be described as “a unit that acquires at least two Internet protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

It should be noted that each embodiment in this specification is described in a progressive way, and each embodiment focuses on the differences from other embodiments, so it is only necessary to refer to the same and similar parts between each embodiment. As for the system or device disclosed in the embodiment, because it corresponds to the method disclosed in the embodiment, the description is relatively simple, and the related points can be found in the description of the method part.

It should be understood that in this application, “at least one (item)” means one or more, and “multiple” means two or more. “and/or” is used to describe the relationship of related objects, indicating that there can be three kinds of relationships. For example, “A and/or B” can indicate that there are only A, only B and both A and B, where A and B can be singular or plural. The character “/” generally indicates that the context object is an OR relationship. “At least one of the following items” or its similar expression refers to any combination of these items, including any combination of single items (items) or plural items (items). For example, at least one of A, B or C can be expressed as: A, B, C, A and B, A and C, B and C, or A and B and C, where A, B and C can be single or multiple.

It should also be noted that in this paper, relational terms such as first and second are only used to distinguish one entity or operation from another entity or operation, and do not necessarily require or imply that there is any such actual relationship or order between these entities or operations. Moreover, the terms “include”, “including” or any other variation thereof are intended to cover non-exclusive inclusion, so that a process, method, article or equipment including a series of elements includes not only those elements, but also other elements not explicitly listed or elements inherent to such process, method, article or equipment. Without further restrictions, an element defined by the phrase “including one” does not exclude the existence of other identical elements in the process, method, article or equipment including the element.

The steps of a method or algorithm described in connection with the embodiments disclosed herein may be directly implemented in hardware, a software module executed by a processor, or a combination of the two. The software module can be placed in random access memory (RAM), internal memory, read-only memory (ROM), electrically programmable ROM, electrically erasable programmable ROM, register, hard disk, removable disk, CD-ROM, or any other storage medium known in the technical field.

The application provides an interaction method, which includes the following steps:
displaying a target page, wherein at least one candidate video is displayed on the target page;
displaying, in response to a selection operation for a target video in the at least one candidate video, a configuration region of at least one configuration item on the target page, wherein the at least one configuration item is obtained by analyzing the target video; and
displaying a new video, wherein the new video is generated based on the target video and configuration information, and the configuration information is determined based on a configuration operation triggered in the configuration region.

In a possible implementation, the at least one configuration item includes one or more of the group consisting of an object replacement configuration item, a pre-roll configuration item, and at least one candidate storyboard; the object replacement configuration item is determined based on a first analysis result of the target video, wherein the first analysis result is configured to indicate whether a preset object exists in the target video; the pre-roll configuration item is determined based on a second analysis result of the target video, wherein the second analysis result is configured to indicate whether the target video satisfies a condition for using a pre-roll; and the at least one candidate storyboard is obtained by parsing storyboards of the target video.

In a possible embodiment, display content in different configuration regions of the candidate storyboard are different; and/or, for any one of the at least one candidate storyboard, display content in the configuration region of the candidate storyboard includes at least one of the group consisting of a type to which the candidate storyboard belongs and image description information of the candidate storyboard.

In one possible implementation, the target page is configured to provide a video processing service for a target account; the process of determining the at least one candidate storyboard includes: parsing storyboards of the target video to obtain at least one first storyboard; determining the at least one candidate storyboard according to a matching result between each first storyboard and a video associated with the target account, wherein the at least one first storyboard includes the at least one candidate storyboard, and for any one of the at least one candidate storyboard, the video associated with the target account does not have any video that matches the candidate storyboard.

In a possible embodiment, the at least one first storyboard further includes a second storyboard, and the video associated with the target account has a video that matches the second storyboard; and the new video is further generated according to the video that matches the second storyboard.

In a possible implementation, the method further includes: displaying a first component on the target page in response to a selection operation; wherein displaying the new video includes: when the first component is in a first state, displaying the new video in response to a trigger operation for the first component, wherein the first state is configured to indicate that the first component is in an available state.

In a possible implementation, displaying the first component on the target page includes:
displaying, in a second state, the first component on the target page, wherein the second state is configured to indicate that the first component is in an unavailable state; wherein before displaying the new video, the method further includes: switching the first component from the second state to the first state in response to the configuration operation.

In a possible implementation, the at least one candidate video is displayed on an information panel of the target page; the method further includes: expanding the information panel in response to the selection operation; and displaying the configuration region of the at least one configuration item on the target page includes: displaying the configuration region of the at least one configuration item in an expanded region of the information panel.

In a possible embodiment, after displaying the configuration region of the at least one configuration item in the expanded region of the information panel, the method further includes:
displaying prompt information in response to a selection operation for a video other than the target video in the at least one candidate video, wherein the prompt information is configured to confirm with a user whether to discard configured content for the target video; and in response to a confirmation operation triggered for the prompt information, deleting the prompt information, and updating display content in the expanded region, wherein updated display content does not include the configured content, and the updated display content is determined by analyzing the video other than the target video.

In one possible implementation, the target page is configured to provide a video processing service for a target account; the at least one candidate video is displayed on an information panel of the target page; and a first title is further displayed on the information panel, wherein the first title is configured to describe a relationship between the target account, the at least one candidate video, and the video processing service, and the first title includes first content with complete semantics, where the first content includes an identifier of the target account.

In a possible embodiment, the method further includes: switching the identifier of the target account in the first title to an identifier of another account in response to a trigger operation for the first title.

In a possible embodiment, the method further includes: displaying a second title corresponding to the new video, wherein the second title is configured to indicate that the new video is generated based on the target video, and the second title includes second content with complete semantics, and the second content includes an identifier of the target video.

In a possible embodiment, the method further includes: displaying an information page in response to a trigger operation for the identifier of the target video in the second title, wherein the information page includes the target video and the configuration information.

In one possible implementation, the target page is configured to provide a video processing service for a target account; the second title is specifically configured to indicate that the new video is generated based on the target video under the target account; and the second content further includes the identifier of the target account.

In a possible embodiment, displaying the new video includes: displaying an execution result of a first task on a result panel of the target page, wherein the first task is a video generation task based on the target video, and the execution result includes the new video; the method further includes: updating the result panel in response to a trigger operation for a second component in the result panel, wherein the updated result panel includes a result display region and a task search region, the result display region displays the execution result of the first task, and the task search region includes at least one historical task; and displaying, in response to a selection operation for the second task in the at least one historical task, an execution result of a second task in the result display region; alternatively, displaying, in response to a keyword entered in a search box in the task search region, an execution result of a historical task that matches the keyword in the result display region.

In a possible embodiment, when the configuration information exists, the new video is generated based on the target video and the configuration information; and when the configuration information does not exist, the new video is generated based on the target video.

The application provides an interactive device, including:
a first display unit configured to display a target page, wherein at least one candidate video is displayed on the target page;
a first selection unit configured to display, in response to a selection operation for a target video in the at least one candidate video, a configuration region of at least one configuration item on the target page, wherein the at least one configuration item is obtained by analyzing the target video; and
a second display unit configured to display a new video, wherein the new video is generated based on the target video and configuration information, and the configuration information is determined based on a configuration operation triggered in the configuration region.

The application provides an electronic device, including: a processor and a memory, wherein the memory is configured to store an instruction or a computer program; and the processor is configured to execute the instruction or the computer program in the memory to implement the interactive method provided by the application.

The application provides a computer-readable medium with an instruction or a computer program stored thereon, when being executed on a device, causes the device to execute the interaction method provided by the application.

The application provides a computer program product, which includes a computer program carried on a non-transitory computer-readable medium, and the computer program contains program code for executing the interactive method provided by the application.

The foregoing description of the disclosed embodiments enables those skilled in the art to make or use this application. Many modifications to these embodiments will be obvious to those skilled in the art, and the general principles defined herein can be implemented in other embodiments without departing from the spirit or scope of this application. Therefore, this application will not be limited to the embodiments shown herein, but is to be accorded the widest scope consistent with the principles and novel features disclosed herein.

1. An interaction method, comprising:
displaying a target page, wherein at least one candidate video is displayed on the target page;
displaying, in response to a selection operation for a target video in the at least one candidate video, a configuration region of at least one configuration item on the target page, wherein the at least one configuration item is obtained by analyzing the target video; and
displaying a new video, wherein the new video is generated based on the target video and configuration information, and the configuration information is determined based on a configuration operation triggered in the configuration region.

2. The method according to claim 1, wherein the at least one configuration item comprises one or more of the group consisting of an object replacement configuration item, a pre-roll configuration item, and at least one candidate storyboard;
the object replacement configuration item is determined based on a first analysis result of the target video, wherein the first analysis result is configured to indicate whether a preset object exists in the target video;
the pre-roll configuration item is determined based on a second analysis result of the target video, wherein the second analysis result is configured to indicate whether the target video satisfies a condition for using a pre-roll; and
the at least one candidate storyboard is obtained by parsing storyboards of the target video.

3. The method according to claim 2, wherein display content in different configuration regions of the candidate storyboard are different;
and/or,
for any one of the at least one candidate storyboard, display content in the configuration region of the candidate storyboard comprises at least one of the group consisting of a type to which the candidate storyboard belongs and image description information of the candidate storyboard.

4. The method according to claim 2, wherein the target page is configured to provide a video processing service for a target account;
process of determining the at least one candidate storyboard comprises:
parsing storyboards of the target video to obtain at least one first storyboard;
determining the at least one candidate storyboard according to a matching result between each first storyboard and a video associated with the target account, wherein the at least one first storyboard comprises the at least one candidate storyboard, and for any one of the at least one candidate storyboard, the video associated with the target account does not have any video that matches the candidate storyboard.

5. The method according to claim 4, wherein the at least one first storyboard further comprises a second storyboard, and the video associated with the target account has a video that matches the second storyboard; and
the new video is further generated according to the video that matches the second storyboard.

6. The method according to claim 1, further comprising:
displaying a first component on the target page in response to the selection operation; and
wherein displaying the new video comprises:
when the first component is in a first state, displaying the new video in response to a trigger operation for the first component, wherein the first state is configured to indicate that the first component is in an available state.

7. The method according to claim 6, wherein displaying the first component on the target page comprises:
displaying, in a second state, the first component on the target page, wherein the second state is configured to indicate that the first component is in an unavailable state;
wherein before displaying the new video, the method further comprises:
switching the first component from the second state to the first state in response to the configuration operation.

8. The method according to claim 1, wherein the at least one candidate video is displayed on an information panel of the target page;
the method further comprises;
expanding the information panel in response to the selection operation; and
wherein displaying the configuration region of the at least one configuration item on the target page comprises:
displaying the configuration region of the at least one configuration item in an expanded region of the information panel.

9. The method according to claim 8, wherein after displaying the configuration region of the at least one configuration item in the expanded region of the information panel, the method further comprises:
displaying prompt information in response to a selection operation for a video other than the target video in the at least one candidate video, wherein the prompt information is configured to confirm with a user whether to discard configured content for the target video; and
in response to a confirmation operation triggered for the prompt information, deleting the prompt information, and updating display content in the expanded region, wherein updated display content does not comprise the configured content, and the updated display content is determined by analyzing the video other than the target video.

10. The method according to claim 1, wherein the target page is configured to provide a video processing service for a target account;
the at least one candidate video is displayed on an information panel of the target page; and
a first title is further displayed on the information panel, wherein the first title is configured to describe a relationship between the target account, the at least one candidate video, and the video processing service, and the first title comprises first content with complete semantics, where the first content comprises an identifier of the target account.

11. The method according to claim 10, further comprising:
switching the identifier of the target account in the first title to an identifier of another account in response to a trigger operation for the first title.

12. The method according to claim 1, further comprising:
displaying a second title corresponding to the new video, wherein the second title is configured to indicate that the new video is generated based on the target video, and the second title comprises second content with complete semantics, and the second content comprises an identifier of the target video.

13. The method according to claim 12, further comprising:
displaying an information page in response to a trigger operation for the identifier of the target video in the second title, wherein the information page comprises the target video and the configuration information.

14. The method according to claim 12, wherein the target page is configured to provide a video processing service for a target account;
the second title is specifically configured to indicate that the new video is generated based on the target video under the target account; and
the second content further comprises an identifier of the target account.

15. The method according to claim 1, wherein displaying the new video comprises:
displaying an execution result of a first task on a result panel of the target page, wherein the first task is a video generation task based on the target video, and the execution result comprises the new video;
the method further comprises:
updating the result panel in response to a trigger operation for a second component in the result panel, wherein updated result panel comprises a result display region and a task search region, the result display region displays the execution result of the first task, and the task search region comprises at least one historical task; and
displaying, in response to a selection operation for the second task in the at least one historical task, an execution result of a second task in the result display region; alternatively, displaying, in response to a keyword entered in a search box in the task search region, an execution result of a historical task that matches the keyword in the result display region.

16. The method according to claim 1, wherein when the configuration information exists, the new video is generated based on the target video and the configuration information; and
when the configuration information does not exist, the new video is generated based on the target video.

17. An electronic device, comprising:
at least a processor, and
a non-transitory memory with instructions thereon,
wherein the instructions upon execution by the processor, cause the processor to:
display a target page, wherein at least one candidate video is displayed on the target page;
display, in response to a selection operation for a target video in the at least one candidate video, a configuration region of at least one configuration item on the target page, wherein the at least one configuration item is obtained by analyzing the target video; and
display a new video, wherein the new video is generated based on the target video and configuration information, and the configuration information is determined based on a configuration operation triggered in the configuration region.

18. The electronic device according to claim 17, wherein the at least one configuration item comprises one or more of the group consisting of an object replacement configuration item, a pre-roll configuration item, and at least one candidate storyboard;
the object replacement configuration item is determined based on a first analysis result of the target video, wherein the first analysis result is configured to indicate whether a preset object exists in the target video;
the pre-roll configuration item is determined based on a second analysis result of the target video, wherein the second analysis result is configured to indicate whether the target video satisfies a condition for using a pre-roll; and
the at least one candidate storyboard is obtained by parsing storyboards of the target video.

19. A non-transitory computer-readable storage medium storing instructions that cause at least a processor to:
display a target page, wherein at least one candidate video is displayed on the target page;
display, in response to a selection operation for a target video in the at least one candidate video, a configuration region of at least one configuration item on the target page, wherein the at least one configuration item is obtained by analyzing the target video; and
display a new video, wherein the new video is generated based on the target video and configuration information, and the configuration information is determined based on a configuration operation triggered in the configuration region.

20. The non-transitory computer-readable storage medium according to claim 19, wherein the at least one configuration item comprises one or more of the group consisting of an object replacement configuration item, a pre-roll configuration item, and at least one candidate storyboard;
the object replacement configuration item is determined based on a first analysis result of the target video, wherein the first analysis result is configured to indicate whether a preset object exists in the target video;
the pre-roll configuration item is determined based on a second analysis result of the target video, wherein the second analysis result is configured to indicate whether the target video satisfies a condition for using a pre-roll; and
the at least one candidate storyboard is obtained by parsing storyboards of the target video.
